(19) United States
(12) Patent Application Publication
(10) Pub. No.: US 2026/0046622 A1
(43) Pub. Date: Feb. 12, 2026

(54) Methods, Devices and Systems for Securing Wireless Systems from Insider Information Attacks

(71) Applicant: Cypress Semiconductor Corporation, San Jose, CA (US)

(72) Inventors: Abhik Chitta Ghanti, Barddhaman (IN); Vinoth SAMPATH, Bangalore (IN); Hul LUO, Marlboro, NJ (US); Ramanathan RAMAKRISHSHNAN, Bangalore (IN)

(73) Assignee: Cypress Semiconductor Corporation, San Jose, CA (US)

(21) Appl. No.: 18/733,706

(22) Filed: Jun. 4, 2024

Related U.S. Application Data
(60) Provisional application No. 63/543,406, filed on Oct. 10, 2023.

(51) Int. Cl. H04W 12/069; H04W 12/037; H04W 28/06; H04W 84/12

(52) U.S. Cl. CPC H04W 12/069; H04W 12/037; H04W 28/06; H04W 84/12

(57) ABSTRACT

A method can include, by operation of a first wireless device, receiving wireless messages from a wireless network, determining that a received wireless message is a disconnect message directing the first wireless device to end communications over the wireless network. The received disconnect message can be determined to not be valid in response to decrypting at least a portion of the received disconnect message, and failing to find a shared secret value previously established during a network joining operation of the first wireless device, or, after transmitting a query message addressed to at least a source address of the received disconnect message, receiving more response messages than expected. A disconnect message determined not to be valid can be ignored. Corresponding devices and systems are also disclosed.

### CROSS-REFERENCE TO RELATED APPLICATIONS

The present application claims the priority and benefit of U.S. Patent Application No. 63/543,406 filed on Oct. 10, 2023, the contents of which are incorporated by reference herein in their entirety.

### TECHNICAL FIELD

The present disclosure relates generally to wireless systems, and more particular to wireless systems that can protect themselves from attacks using insider information, such as the addresses and/or identification values of devices that have already joined the network.

### BACKGROUND

Wireless systems, such as systems compatible with some IEEE 802.11 wireless standards, can be susceptible to attacks using the media access control (MAC) address of a station device (STA) that is already associated with a basic service set (BSS), including a BSS of a distributed system (DS) (i.e., a MAC stealer attack).

One type of MAC stealer attack can override a security context of an associated STA (the “victim” STA). In such an attack, an attacker can disconnect a victim STA from an access point device (AP) using a variety of methods, including with a de-authentication frame having management frame protection (MFP). The attacker can then connect to the AP using the victim STA MAC address. Such an attack need not require tight timing between attacker messages, as a request from a victim STA could be resent by an endpoint (e.g., HTTP response data by TCP transmission). One example of a security context override attack is shown in FIG. 35.

Referring to FIG. 35, a system 3501 can have an AP 3505 that can control access to a BSS. A STA 3503 can join a network using an exchange of association messages 3509. Such a method can include any suitable association methods and authentication/security steps, including but not limited to Passpoint, promulgated by the Wi-Fi Alliance or WPA-3 (including an Enterprise mode). Such methods can include simultaneous authentication of equals public key (SAE-PK) authentication steps.

Once associated, a STA 3503 can issue HTTP requests 3511 for servicing by AP 3505. However, before the HTTP request 3511 can be serviced, an attacker 3508 in possession of the MAC address of STA 3503 can spoof a deauthentication message 3508-0 addressed to STA 3503. An attacker 3508 can then seek connection to AP 3505 using the misappropriated MAC address and its own credentials 3513. The AP 3505 can mistakenly overwrite 3505-0 the security context corresponding to STA 3503 with a new context established and controlled by attacker 3508. An AP 3505 can then mistakenly prepare a response data frame to the HTTP request using the overwritten context and send it to the (misappropriated) MAC address of attacker 3505-1. In this way, attacker can acquire downlink data intended for STA 3503.

Another type of MAC stealer attack is a fast reconnection attack. A fast reconnection attack can be aimed at a DS having more than one AP. Assuming a victim STA is connected to a first AP (AP1), an attacker can connect to a second AP (AP2) using the victim STA's MAC address. The DS can then deliver downlink traffic (intended for the victim STA) to the attacker via AP2, as a DS can be configured to forward traffic to the AP with whom the MAC address was last authenticated. One example of a fast reconnection attack is shown in FIG. 36.

Referring to FIG. 36, a system 3601 can include a DS 3605 with two APs (AP1 3605-0, AP2 3605-1). A STA 3603 can associate with DS 3605 via AP1 3605-0 with connection and authentication steps 3615. An attacker 3608 can associate with AP2 3605-1 using a spoofed MAC address 3613 (i.e., MAC address of STA 3603). In response, AP2 3605-1 can begin associating with the attacker 3608. In the example shown, this can include association and authentication, including a four-way handshake 3617. AP2 3605-1 can cache a pairwise master key (PMK) 3605-10 negotiated with the attacker. AP2 3605-1 can use PMKID to keep track of the PMK associated with the (spoofed) MAC 3621.

STA 3603 can issue a request 3619 to DS 3605 via AP1 3605-0. However, due to the association by attacker 3621, AP2 3605-1 can load the cached PMK (generated with the attacker credentials) 3605-11. A four-way handshake can be executed 3623 between attacker 3606 and AP2 3605-1 to establish encryption keys. Because the attacker's association is the most recent, DS 3605 can transmit a response 3625 (corresponding to request 3619) to attacker 3608 rather than STA 3603.

Any way of preventing or otherwise thwarting such insider information attacks could greatly contribute the security of wireless systems.

### SUMMARY

A method can include, by operation of a first wireless device, receiving wireless messages from a wireless network, determining that a received wireless message is a disconnect message directing the first wireless device to end communications over the wireless network. The received disconnect message can be determined to be invalid in a number of ways. In one way, at least a portion of the received disconnect message can be decrypted. If a shared secret value is not found, the disconnect message can be determined invalid. A shared secret value can be a value previously established during a network joining operation by the first wireless device. In another way, in response to a disconnect message, a first wireless device can transmit a query message addressed to at least a source address of the received disconnect message. If the first wireless device receives more response messages than expected (e.g., both the valid device and attacker respond to the query), the disconnect message can be determined to be invalid. An invalid disconnect message can be ignored. Corresponding devices and systems are also disclosed.

### BRIEF DESCRIPTION OF DRAWINGS

FIG. 1 is a signaling diagram showing a system and corresponding operations according to an embodiment.

FIG. 2 is a signaling diagram showing a system and corresponding operations according to another embodiment.

FIG. 3 is a signaling diagram showing a system and corresponding operations according to a further embodiment.

FIG. 4 is a signaling diagram showing a system and corresponding operations according to another embodiment.

FIG. 5 is a signaling diagram showing a system and corresponding operations according to another embodiment.

FIG. 6 is a diagram of a secure session notification data frame according to an embodiment.

FIG. 7 is a diagram of a secure session notification data frame according to another embodiment.

FIG. 8 is a diagram of a secure session request data frame according to an embodiment.

FIG. 9 is a diagram of a secure session request data frame according to another embodiment.

FIG. 10 is a diagram of a secure session response data frame according to an embodiment.

FIG. 11 is a diagram of a secure session response data frame according to another embodiment.

FIG. 12 is a diagram of a data frame that contains secure session data according to an embodiment.

FIG. 13 is a diagram of a data frame that includes a secure session identity information element according to an embodiment.

FIG. 14 is a diagram of a secure session update data frame according to an embodiment.

FIG. 15 is a diagram of a secure session update data frame according to another embodiment.

FIG. 16 is a diagram of a secure session update acknowledgement (ACK) data frame according to an embodiment.

FIG. 17 is a diagram of a secure session update ACK data frame according to another embodiment.

FIG. 18 is a diagram of a secure session data request data frame according to an embodiment.

FIG. 19 is a diagram of a secure session data request data frame according to another embodiment.

FIG. 20 is a diagram of a response to a secure session data request according to an embodiment.

FIG. 21 is a diagram of a response to a secure session data request according to another embodiment.

FIG. 22 is a flow diagram of a method according to an embodiment.

FIG. 23 is a flow diagram of a method according to another embodiment.

FIG. 24 is a flow diagram of a method according to a further embodiment.

FIGS. 25-0 and 25-1 show a flow diagram of a method according to another embodiment.

FIG. 26 is a flow diagram of a method according to another embodiment.

FIG. 27 is a flow diagram of a method according to another embodiment.

FIG. 28 is a flow diagram of a method according to another embodiment.

FIG. 29 is a block diagram of a device according to an embodiment.

FIG. 30 is a block diagram of an access point device according to an embodiment.

FIG. 31 is a block diagram of a station device according to an embodiment.

FIG. 32 is a diagram of an integrated circuit device according to an embodiment.

FIG. 33 is a diagram of a vehicle system according to an embodiment.

FIG. 34 is a diagram showing a system with Internet-of-Things (IoT) type devices according to an embodiment.

FIG. 35 is a signaling diagram showing a first type insider information attack.

FIG. 36 is a signaling diagram showing a second type insider information attack.

### DETAILED DESCRIPTION

According to embodiments, a wireless network can be protected against attackers having “insider” information, such as a device media access control (MAC) address, as but one example.

According to some embodiments, a wireless device can establish a secure session data with another device when joining a network. Secure session data can include a device identification value (ID) and a shared secret. A shared secret can be a value known to both devices. When the wireless device receives a disconnect message directing it to cease communications on the wireless network, the disconnect message can be further decrypted. If the decrypted message does not include the shared secret, the termination message can be ignored.

In some embodiments, a wireless network can be compatible with one or more IEEE 802.11 wireless standards, and a disconnect message can be a disassociation or deauthentication frame. A network joining operation that establishes a shared secret can be established during an association operation.

In some embodiments, a first access device (e.g., an access point device, AP) can transmit its secure session data to a second access device of a same network (e.g., a distributed system, DS). Conversely, the second access device can provide its secure session data to the first access device.

In some embodiments, in response to receiving a request to re-join a network with a known device ID, an access device can decrypt the request. If the decrypted request does not include a corresponding shared secret, the request to re-join can be ignored. Alternatively, the request to re-join can be honored, but messages addressed to the requesting device can be dropped for a timeout period.

According to embodiments, when a wireless device receives a disconnect, the wireless device can issue a query message to the apparent source of the termination message. A query message can be a type of message that elicits a response message from a target device. If the wireless device receives two or more response messages, the termination message can be ignored. In some embodiments, a wireless device can check a disconnect message in this way if a session corresponding to the disconnect message is active.

In some embodiments, a wireless network can be compatible with one or more IEEE 802.11 wireless standards, and a query message can include, but is not limited to, a block acknowledgement request (BAR), power saving poll message (PS-Poll), or a null data frame.

According to embodiments, wireless network operations can provide additional security features to existing protocols (e.g., new information elements, IEs) that enable an access device to verify if a joining device possesses a shared secret with the access device. Such a shared secret can have been previously established when the requesting device previously joined the wireless network. If the joining device does not present the shared secret, the access device can reject the joining device or accept the joining device, but drop any pending messages for the joining device for a predetermined time period.

According to embodiments, upon joining a wireless network, devices can establish a shared secret. Such a shared secret can be used as an additional layer of security to defeat attacks that use messages to remove a device from a network (e.g., a disassociate or deauthenticate message).

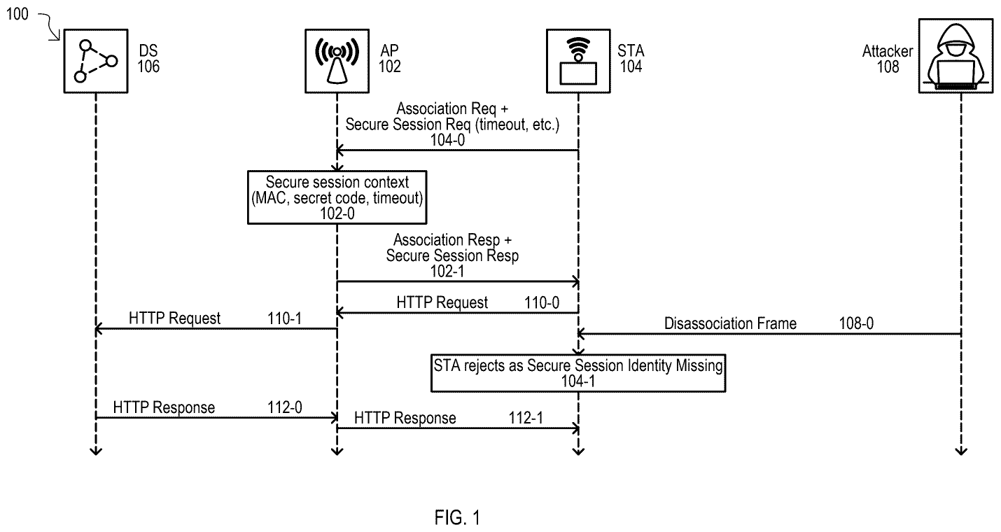

FIG. 1 is a signaling diagram showing operations of a system 100 according to an embodiment. A system 100 can include an access device (e.g., AP) 102, a client device (e.g., STA) 104, and remaining portions of a DS 106. FIG. 1 also show an attacker 108 that is in possession of a device (e.g., MAC) address of STA 104. A system 100 can operate by devices (AP 102, STA 104) transmitting and receiving protocol data units (PDU) according to one or more wireless standards. In some embodiments, a system 100 can be compatible with one or more IEEE 802.11 wireless standards (referred to herein as WLAN). However, alternate embodiments can include any suitable wireless standards that include a joining stage (e.g., association) that can establish an encryption scheme for data frame values above the layer with a device address.

Referring to FIG. 1, operations of a system 100 will now be described. A STA 104 can transmit a request to join a wireless network 104-0, where access to the network can be controlled by AP 102. Such a request to join 104-0 can indicate an additional level of security (e.g., a secure session), and include values associated with such additional security, including but not limited to, method for generating a shared secret (described in more detail below) and a timeout value.

In some embodiments, a request to join 104-0 can be a WLAN compatible association request. Further, such an association request can be transmitted after detecting a beacon from the AP 102 or after transmitting a probe and receiving a probe response from AP 102. In some embodiments, a beacon, probe request, or probe response can indicate that AP 102 is capable of the secure session operations. In some embodiments, a request to join can include a device (e.g., MAC) address, indicate an action (e.g., generate secure session data), and a timeout value. A timeout value will be described in more detail below.

In response to a secure session request to join a network 104-0, AP 102 can generate secure session context data 102-0. Secure session context data can include, but is not limited to, a device (e.g., MAC) address, a shared secret (e.g., secret code) and a timeout period. It is understood that such a data set (e.g., tuple) can be generated when any secure session compatible device joins the network. Once secure session context data has been generated, AP 102 can transmit a response 102-1 to STA 102 that includes secure session context data. In some embodiments, such a response can be an association response with a secure session response. In some embodiments, AP 102 can also transmit secure session data for STA 102 to other access devices of a system 100.

Upon receiving response 102-1, STA 104 can have established the necessary encryption scheme for communicating on the wireless network, as well as confirmation that communications can include secure session operations. In some embodiments, a STA 104 can generate a shared secret with data provided by AP 102. In other embodiments, a shared secret can take any suitable form, including encryption keys arrived at when establishing the cryptographic scheme for communications over the wireless network. In some embodiments, secret values can include, but are not limited to a pairwise master key (PMK) or pairwise transient key (PTK) generated during a WLAN association operation.

FIG. 1 shows STA 104 communicating over the wireless network with a message 110-0 transmitted to AP 102, which can be relayed to other portions of system 106 as forwarded message 110-1.

FIG. 1 shows operations of system 100 in response to an attempt to access data by an attacker 108 in possession of the MAC address of AP 104. An attacker 108 can transmit a message 108-0 indicating that STA 104 should disconnect from the wireless network. In some embodiments, such a disconnect message can be a WLAN disassociation frame or deauthentication frame.

Upon receiving termination message 108-0, STA 104 can decrypt the message to determine if it is in possession of the shared secret associated with AP 102. Because the attacker 108 is not in possession of the shared secret (as it could not have executed the same association operation as STA 104), STA 104 can reject (e.g., ignore) the termination message 104-1, and remain active on the wireless network. Consequently, STA 104 can receive a message 112-0/112-1 over the network. Had attacker 108 succeeded in disconnecting STA 104, such a message 112-0/112-1 would have been missed, and possibly received by attacker 108.

In this way, when a device joins a wireless network, it can establish a shared secret with a device that controls access to the network (e.g., AP). After the device has joined the network, when it receives a disconnect message, such a disconnect message can be subject to a higher level of security by looking for the shared secret. If the shared secret is not present in the disconnect message, the disconnect message can be ignored.

While a shared secret established upon joining a network can be used to defeat attacks using invalid messages to disconnect from a network (e.g., a disassociate or deauthenticate message), such values can also be used to defeat attacks that seek to join a network using another device ID (e.g., MAC address).

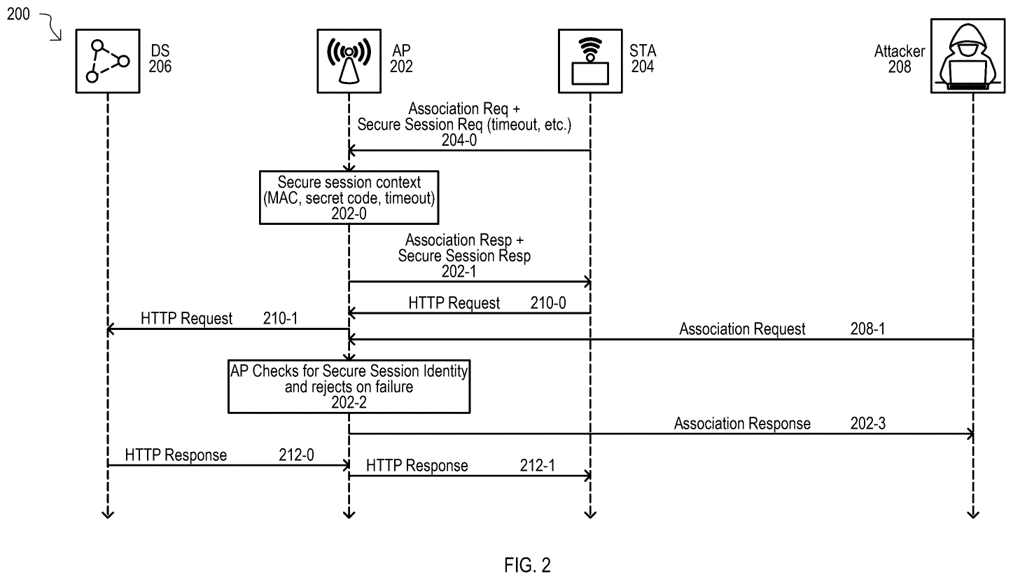

FIG. 2 is a signaling diagram showing operations of a system 200 according to another embodiment. A system 200 can include operations like those shown in FIG. 1, and such like operations are referred to by the same reference character but with the leading digit being a “2” instead of “1”. In some embodiments, a system 200 can be a WLAN compatible system.

FIG. 2 can differ from FIG. 1 in that an attacker can transmit an association request 208-1 using a device ID (e.g., MAC address) of STA 204. Upon receiving the “spoofed” association request 208-1, AP 202 can decrypt the message to determine if it is in possession of the shared secret associated with STA 204 (action 202-2). Because the attacker 208 is not in possession of the shared secret, AP 202 can determine that the association request 208-1 is invalid. An AP 202 can return an association response 202-3 denying the association request. Such a denial can include an indication directing a retry at a later time. Consequently, STA 204 can receive a message 212-0/211-1 over network that might have been intercepted by attacker 208, had the attacker 208 been successful in joining the network.

In this way, when a device joins a wireless network, a shared secret can be established with an access device that controls access to the network (e.g., AP). When the access device receives a request to join the network (e.g., association request) from a device determined to have previously joined the wireless network (and not yet left the wireless network), such a message can be subject to a higher level of security by looking for the shared secret. If the shared secret is not present in the request, the request to join can be ignored/denied.

While a shared secret established upon joining a network can be used to defeat spoofed messages for joining (e.g., association) and/or leaving (e.g., disassociation/deauthentication) a wireless network, such shared secrets can also be transmitted to other access devices of a larger network to prevent spoof attacks from different access points to the wireless network.

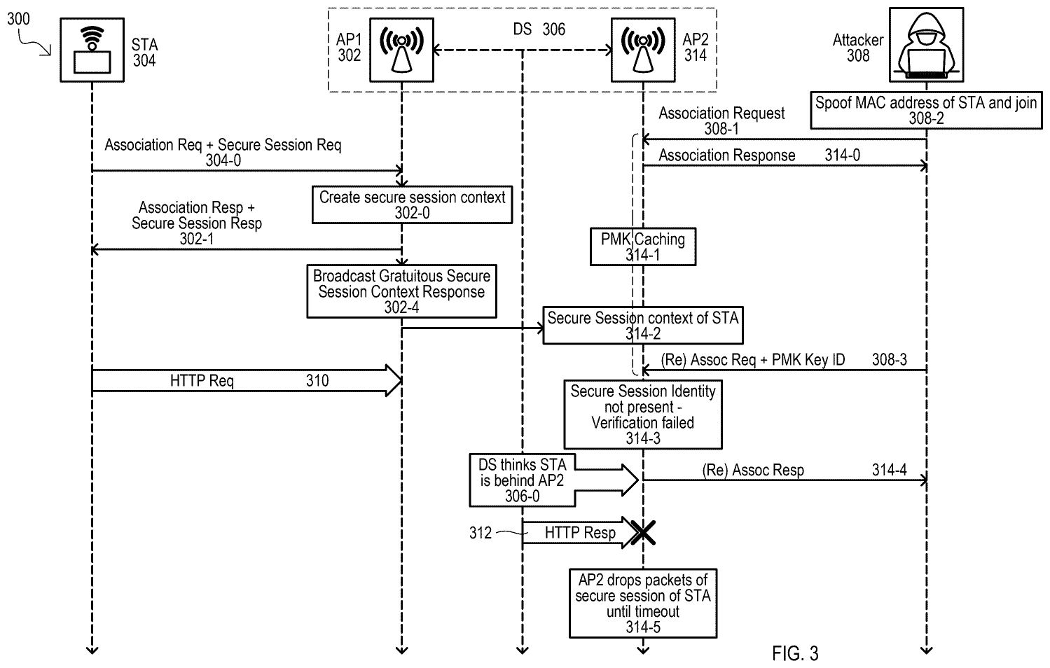

FIG. 3 is a signaling diagram showing operations of a system 300 according to another embodiment. A system 300 can include operations like those shown in FIG. 1, and such like operations are referred to by the same reference character but with the leading digit being a “3” instead of “1”. In some embodiments, a system 300 can be a WLAN compatible system.

A system 300 can differ from that shown in FIG. 1 in that is shows both a first access device (AP1) 302 and a second access device (AP2) 314 that can be in communication with one another to form a larger network 306 (e.g., DS). A STA 304 and AP1 302 can execute an association operation as described for other embodiments, or an equivalent, including an association request 304-0, the creation of secure session context data 302-0, and an association response 302-1.

Referring still to FIG. 3, at AP2, an attacker 308 can join a system 300 using a device ID of STA 304 (action 308-2). Attacker 308 can request to join a network 308-1, and receive a response from AP2 314 (action 314-0). AP2 314 can proceed with network joining operations, including storing cryptographic keys (e.g., PMK) 314-1 established when attacker 308 joined the network. Thus, using a device ID of STA 304, attacker 308 has managed to join a network through an access device (AP2 314) that has not been in communication with STA 304.

In response to AP1 302 establishing secure session context 302-0 corresponding to STA 304, AP1 302 can broadcast such secure session context data 302-4. In some embodiments, such a broadcast can be gratuitous. In other embodiments, other access devices, such as AP2 314 can request updates on secure session context data.

AP2 314 can receive secure session context data 314-2 for STA 304 (from AP1 302). FIG. 3 shows attacker 308 attempting an association or reassociation (referred to as (re)association) operation 308-3 with AP2 314 using previously established credentials (e.g., PMK established by association operation 308-1/314-0) as well as a device ID (e.g., MAC address) of STA 304. However, AP2 314 is now in possession of secure session data for STA 304 due to gratuitous broadcast 302-4 from AP1 302. Consequently, in response to the (re)association request 308-3, AP2 314 can further examine the request for additional security data corresponding to secure session data, such as a shared secret. Such an action can include decrypting a portion of the received request. Because attacker 308 is not in possession of the secret shared between STA 304 and AP1 302, verification fails 314-3. In the event DS 306 erroneously believes STA 304 is behind AP2 314 (306-0), a (re)association response 314-4 can be returned, which may complete a (re)association operation. However, data for transmission will be dropped for a timeout period, preventing attacker 308 from illicitly receiving such data. Thus, as shown in FIG. 3, response data 312, which may correspond to request 310 from STA 304, will not be forwarded to attacker 308. Further, AP2 314 will drop messages (e.g., packets) corresponding to the secure session data of STA 304 for a timeout period 314-5.

In this way, secure session data established by one access device (e.g., AP) can be transmitted to another access devices of a same extended network (e.g., DS). Thus, an attacker posing as a device connected to one access device can be detected as it seeks to join the network through another access devices of the extended network.

While secure session data be broadcast from one access device to other access devices of a same larger system, in other embodiments, an access device can request secure session data from other access devices of a same extended network. Devices seeking to re-join the network can be verified using secure session data requested from other access devices.

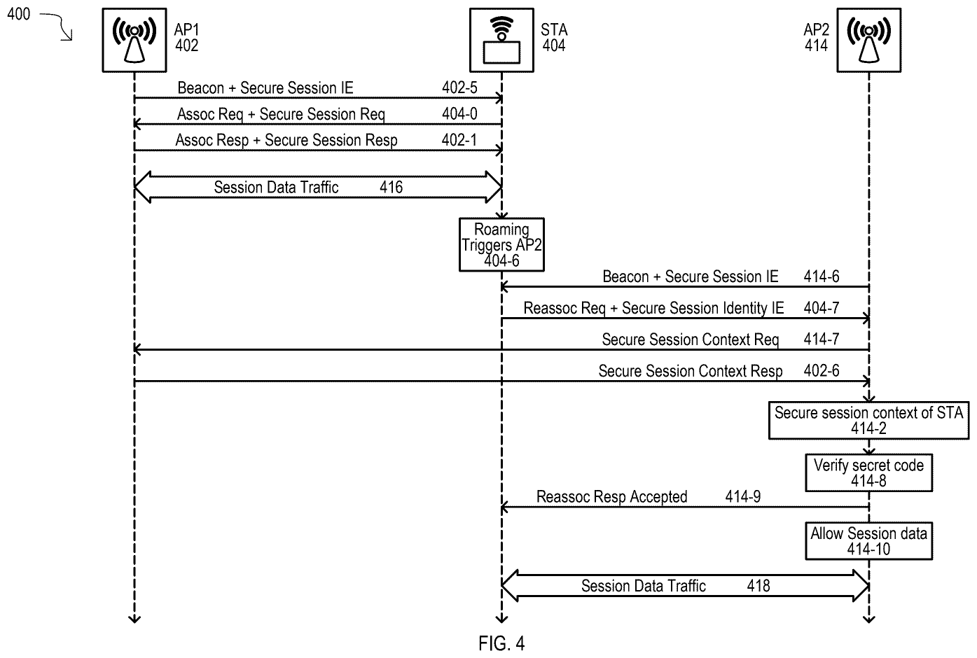

FIG. 4 is a signaling diagram showing operations of a system 400 according to a further embodiment. A system 400 can include operations like those shown in FIG. 3, and such like operations are referred to by the same reference character but with the leading digit being a “4” instead of “3”. In some embodiments, a system 400 can be a WLAN compatible system.

System 400 and operations show a first access device AP1 402 broadcasting its capability to establish higher security connections using secure session data according to embodiment described herein or equivalents. In the embodiment shown, such an action can include transmitting a beacon 402-5 with an IE that includes data indicating the secure session ability. STA 402 can detect the beacon and request association that uses secure session data 404-0. AP1 402 can return an association response indicating a secure session 402-1. Such actions can establish an encryption scheme for communications between AP1 402 and STA 404, as well as secure session data, including but not limited to a secret value shared between AP1 402 and STA 404. AP1 402 and STA 404 can then exchange messages (shown as session data traffic 416).

In the embodiment shown, STA 404 can switch between access devices (e.g., APs) based on predetermined criteria, including but not limited to, signal strength, loss of packets, or quality of service. In the embodiment shown, roaming 404-6 by STA 404 can trigger a search for another (e.g., better) access device of an extended network. As a result, STA 404 can detect a broadcast 414-6 from AP2 414. Such a broadcast 414-6 can take the form of that described for 402-5 of AP1 402. In some embodiments, AP2 414 can be an access device for a same extended network (e.g., DS) as AP1 402.

Upon detecting broadcast 414-6, STA 404 can attempt to rejoin the system at AP2 414. In the embodiment shown, such an attempt can include a re-association request 404-7 to AP2 414 with an IE indicating the previously established secure session data. Such data may not include a shared secret with AP1 402. Upon receiving the request 404-7, AP2 414 can transmit a request 414-7 to AP1 402 for the secure session context data corresponding to STA 404. Such a request 414-7 can use data provided by the request to rejoin 404-7 from STA 404.

In response to the request for secure session context 414-7 from AP2 414, AP1 402 can return a secure session context response 402-6. Such a response 402-6 can include secure session data established when STA 404 joined the system 400 via AP1. In some embodiments, such data can include a secret value shared between AP1 402 and STA 404. AP2 414 can receive and store 414-2 secure session context data received from AP1 402. Using secure session context data, AP2 414 can verify the request to rejoin received from STA 404 by ensuring the message includes a secret code (e.g., secret value shared with AP1 402) known or derived from secure session context data from AP1 402. If the request to rejoin 404-7 can be so verified, AP2 414 can return a response indicating the request has been honored 414-9. AP2 414 can then allow session data 414-10 with STA 402, and messages can be transmitted between AP2 414 and STA 404 (shown as session data traffic 418).

In some embodiments, if AP2 414 cannot verify a request to rejoin 404-7, AP2 414 can ignore the request or honor the request, but drop messages for STA 402 (or what appears to be STA 402) for a predetermined amount of time.

In this way, when an access device (e.g., AP) receives a request to rejoin a wireless network that indicates the requesting device was previously connected to the network, the access device can request secure session data from other access devices of the same network. Such secure session data can include a secret value shared between another access device corresponding to the requesting device.

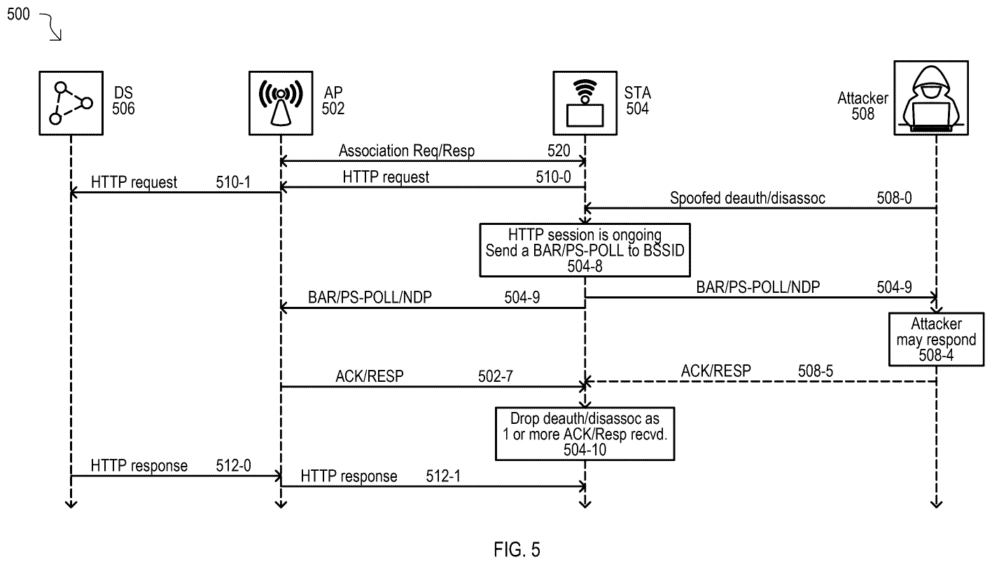

While embodiments can utilize secure session data established in a network joining operation (e.g., association), such approaches can involve the decryption of at least a portion of a received message (e.g., to detect a shared secret value). Alternate embodiments can detect impersonating devices without the increased computation resources and/or time involved in inspecting encrypted packet data. FIG. 5 shows one example of such an embodiment.

FIG. 5 is a signaling diagram showing operations of a system 500 according to another embodiment. A system 500 can include operations like those shown in FIG. 1, and such like operations are referred to by the same reference character but with the leading digit being a “5” instead of “1”. In some embodiments, a system 500 can be a WLAN Compatible System.

FIG. 5 shows an AP 502 and STA 504 executing a network joining operation 520, which in the embodiment shown, can include an association request from STA 504 and a corresponding association response from AP 502. Unlike other embodiments described herein, such a network joining operation 520 may not establish secure session data, such as a shared secret. However, such operations can establish an encryption scheme for communications. Once STA 504 has successfully joined system 500, STA can communicate over the corresponding network. FIG. 5 shows a request 510-0 from STA 504 that can be transmitted to AP 502, which can forward the request 510-1 to other parts of a system 506.

As in the case of FIG. 1, an attacker 508 can be in possession of a device ID (e.g., MAC address) corresponding to STA 504. Attacker 508 can transmit a message to STA 504 directing disconnection from the network. In the example shown, such message can be a deauthentication or disassociation frame 508-0 that identifies the STA 504 as a destination and AP 502 as a source.

In response to spoofed message 508-0, STA 504 can determine whether it is still expecting communications over the connection corresponding to the disconnect message 508-0 (e.g., a corresponding session is ongoing). Such a determination can take any suitable form, including but is not limited to: checking if a port for a peer is still open (e.g., TCP (transmission control protocol) or UDP (user datagram protocol) port); checking if any BA (block acknowledgement) sessions are available; and/or checking if a host (e.g., AP) has any queued packets in for transmission to STA 504.

If STA 504 determines such a connection is still active, the STA 504 can transmit a message intended to elicit a response on the connection 504-8. Such an action can take any suitable form, including but not limited to: a block acknowledgement request (BAR), a power save poll message (PS-POLL) and/or a null data packet (NDP). Such a response eliciting message is shown as 504-9. A response eliciting message 504-9 can be received by AP 502 and attacker 508. Such a message can elicit a response 502-7 from AP 502. If attacker responds 508-4 with its own message 508-5, STA 504 can detect more than one response 504-10, and determine that the disconnect message 508-0 is invalid. STA 504 can ignore the message and remain connected to system 500. Consequently, message data 512-0/1 addressed to STA 504 can be received at STA 504, and not be intercepted by attacker 508 (which could seek to join system 500 using a device ID of STA 504). It is noted such an approach does not require decrypting portions of received messages and checking for shared secret values, or the like. It is noted that while FIG. 5 describes an operation for eliciting a single response, alternate embodiments can seek to elicit more than one response. A STA can then determine a received message is invalid if a number of received responses exceeds the number of expected responses.

In this way, in response to a message to disconnect from a network (e.g., deauthentication/disassociation frame), a device can determine if any corresponding sessions are ongoing. If session(s) are ongoing, the device can transmit a message to elicit a response a device corresponding to the session. If more responses are received than is expected, the message to disconnect can be ignored.

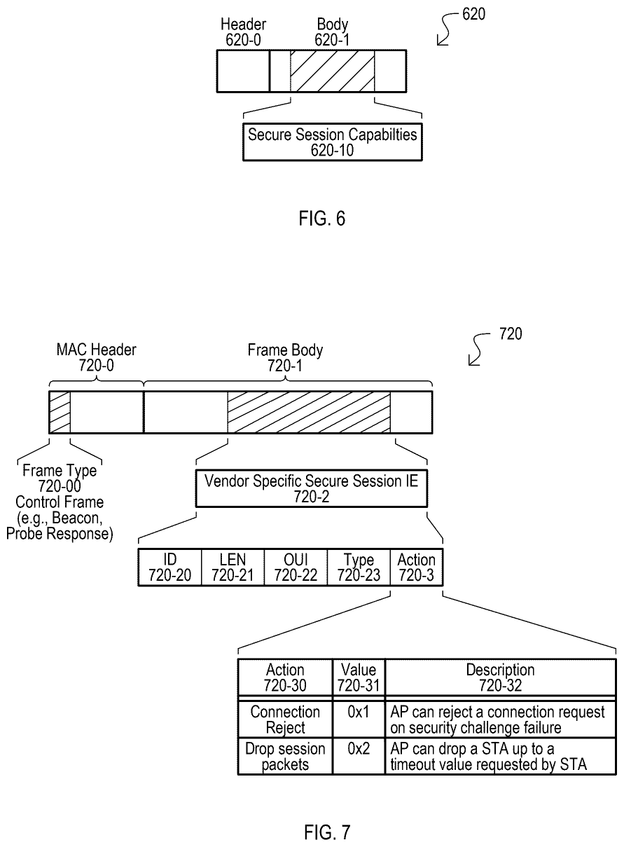

According to embodiments, devices can transmit and receive messages that indicate secure session capabilities, secure session data and/or secure session actions. FIGS. 6 to 21 are diagrams of various data frames according to embodiments. In such diagrams, unless otherwise described, like items can be referred to by the same reference characters but with the leading digit(s) corresponding to the figure number.

FIG. 6 is a diagram of a secure session notification data frame 620 according to an embodiment. A data frame 620 can be compatible with one or more wireless standards, and can include a header 620-0 and a body 620-1. A data frame 620 can be multi-cast or unicast. A header can include a destination address value, and in some embodiments, a source address value. A body 620-1 can include data indicating secure session capabilities 620-10 of the transmitting device. Secure session capabilities 620-10 can indicate security operations available in addition to those provided by the wireless standard(s) under which a system is operating. In some embodiments, secure session capabilities 620-10 can indicate possible responses to such additional security operations (e.g., ignore or accept actions indicated by messages).

In this way, a device controlling access to a network can transmit a message that indicates an ability to perform additional security operations, to enable compatible devices to join a network and operate under such additional security operations.

In some embodiments, additional security features can be a feature provided by a manufacturer.

FIG. 7 is a diagram of a WLAN compatible secure session notification data frame 720 according to an embodiment. Data frame 720 can include a MAC header 720-0 and frame body 720-1. A MAC header 720-0 can include a frame type field 720-00, which can indicate a control frame, which in some embodiments, can be a beacon or a probe response. A frame body 720-1 can include a vendor specific (VS) secure session IE 720-2, which can include a number of fields. An ID field 720-20 can identify the IE as being a vendor specific IE (i.e., a value of 221). A length field (LEN) 720-21 can indicate the length of remaining fields. An organizational unique identifier (OUI) field 720-22 can identify an organization. A Type field 720-23 can indicate secure session data.

An action field 730-3 can indicate actions an AP can perform in the event a secure session verification fails. In the embodiment shown, action field 730-0 can be a bit map, with different bit locations 720-31 indicating different actions 720-30. FIG. 7 includes descriptions of actions 720-32, which can include rejection of a connection request or dropping messages for a STA for a timeout period.

In this way, a WLAN AP can transmit a beacon or probe response with a vendor specific IE that indicates which types of secure session responses (to failed verification) that the AP can provide.

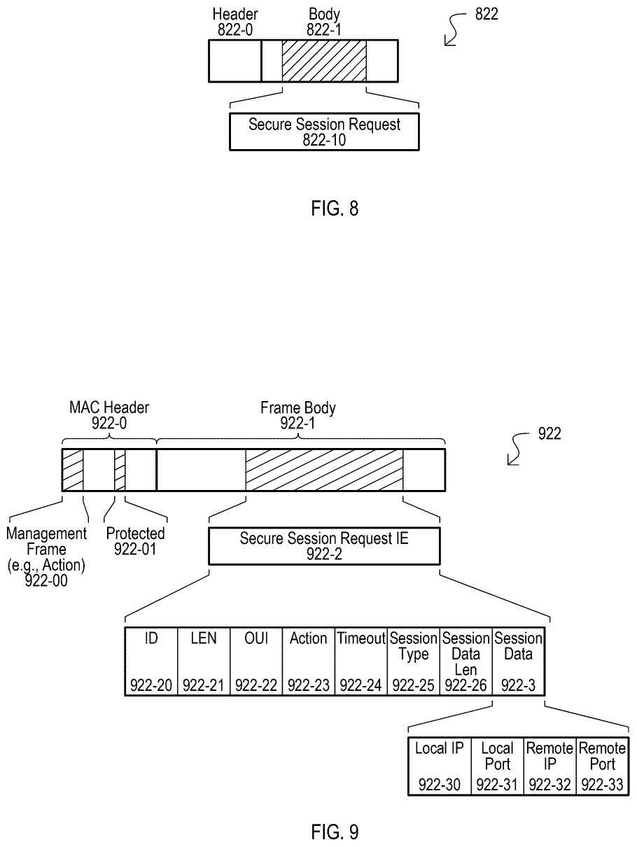

FIG. 8 is a diagram of a secure session request data frame 822 according to an embodiment. A body 822-1 can include data requesting access to a network using secure session capabilities 822-10. Secure session capabilities can include additional security checks or actions taken in response to particular received messages. In some embodiments, particular messages can include messages requesting connection to a network and/or messages directing disconnection from a network.

In this way, in response to an access device indicating joining operations that can include additional security operations, a device can issue a request to join a network using such additional security operations.

FIG. 9 is a diagram of a WLAN compatible secure session request data frame 922. A MAC header 922-0 frame type field 922-00, can indicate a management frame, and in some embodiments an action frame. A MAC header 922-0 can also indicate a frame is a protected management frame (PMF).

A frame body 922-1, which can be encrypted, can include a secure session request IE 922-2 with a number of fields. ID, LEN and OUI fields (922-20 to-22) can correspond to those described in FIG. 7. An Action field 922-23 can indicate an action arising from a secure session failure, including but not limited to, rejecting a request indicated by a message or dropping session packets for a timeout period. A Timeout field 922-24 can define the timeout period (e.g., for dropping packets). A Session Type field 922-25 can indicate a type of session (e.g., UDP or TCP). A Session Data Len field 922-26 can define a size of an optional Session Data field 922-3. Optional Session Data field 922-3 can provide additional data for one or more sessions. As but one example, for an IPv4 type session, session data can include a Local IP address 922-30, Local Port 922-31, a Remote IP address 922-32 and Remote Port 922-33. In some embodiments, Session Data field 922-3 can include data for more than one session.

In this way, a WLAN STA request can include a secure session request IE that can indicate secure session responses, values (e.g., timeout values), and data identifiers.

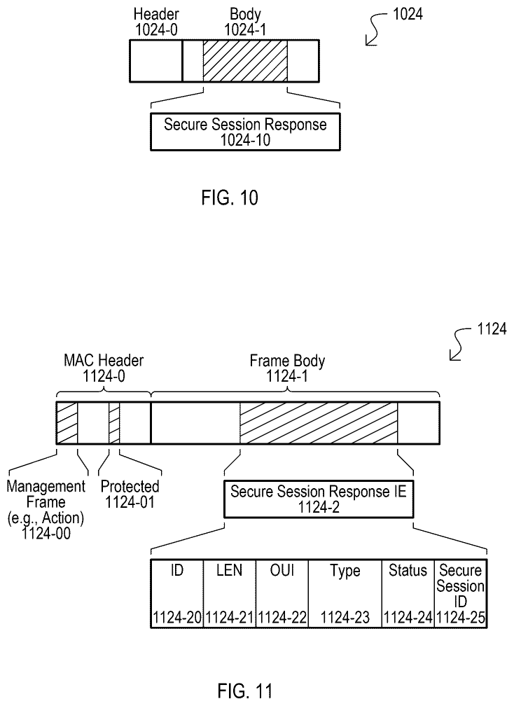

FIG. 10 is a diagram of a secure session response data frame 1024 according to an embodiment. A body 1024-1 can include data indicating a status of a request to join a network to establish a connection with secure session capabilities (e.g., accepted or denied).

In this way, in response to a request to join a network with secure session capabilities, an access device can return a message indicating a state of such a connection.

FIG. 11 is a diagram of a WLAN compatible secure session response data frame 1124. A frame type field 1124-00 of a MAC header 1124-0 can indicate a management frame (e.g., action frame) and that the data frame is a PMF 1124-01. A frame body 1124-1, which can be encrypted, can include a secure session response IE 1124-2 having a number of fields. ID, LEN and OUI fields (1124-20 to-22) can correspond to those described in FIG. 7. A Type field 1124-23 can indicate the type of IE (i.e., a response to a secure session request). A Status field 1124-24 can indicate a response to a request (e.g., accept or reject). A Secure session ID field 1124-25 can include unique value corresponding to the session corresponding to a secure session request.

In this way, a WLAN AP can respond to a secure session request, with a response that includes an IE indicating a status of the request as well as a unique ID corresponding to a secure session.

Embodiments can include messages containing security values for enabling a higher level of security in wireless communications to address attacks using messages impersonating a device ID. Such security values can include a value that is a shared secret established between two devices when initially joining a network.

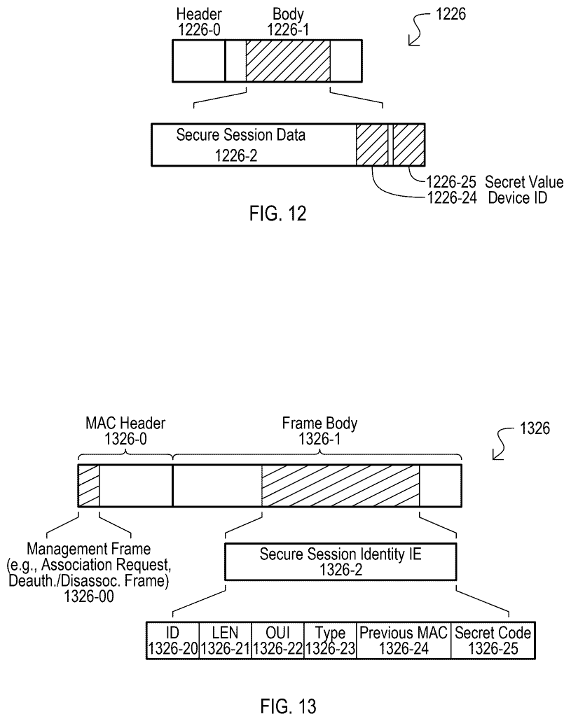

FIG. 12 is a diagram of a data frame 1226 that can contain secure session context data according to an embodiment. Such a data frame can be a message from a device controlling access to a network (e.g., AP) as well as a device seeking to join or rejoin a network (e.g., STA). A body 1226-1 can include secure session data 1226-2, including a device ID 1226-24 and a secret value 1226-25. A device ID 1226-24 can be that established for a device in previous communications. A secret value 1226-5 can be value established in previous communications (e.g., upon joining a network), and can be a value that is shared between two devices. At least a secret value 1226-25 can be encrypted. Upon receiving data frame 1226, a device can decrypt the secret value and determine if it matches its own secret value. This can provide additional security, as an imposter using a device ID 1226-24 will not be in possession of such a secret value 1226-25.

In this way, messages from device operating over a secure session connection can include encrypted shared secret values to prevent imposter messages from affecting network operations.

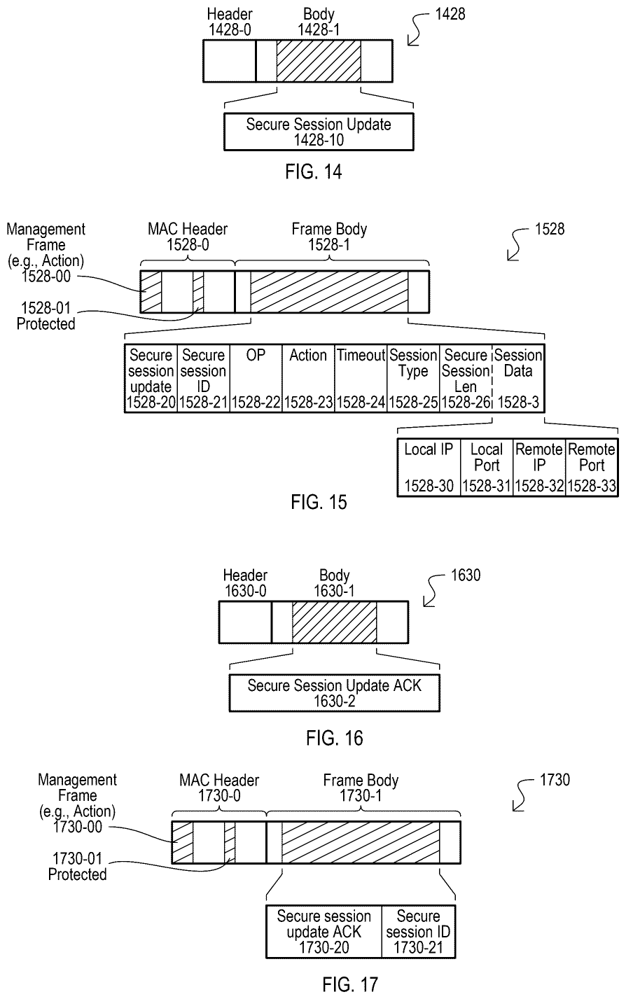

FIG. 13 is a diagram of a WLAN compatible data frame 1326 having a secure session identity IE 1326-2. A frame type field 1324-00 of a MAC header 1324-0 can indicate a management frame. Such a management frame value 1326-0 can indicate a data frame originating from a STA (e.g., (re)association request) or AP (e.g., deauthentication/disassociation frame).

A frame body 1326-1, which can be encrypted, can include secure session identity IE 1326-2 having a number of fields. ID, LEN and OUI fields (1326-20 to-22) can correspond to those described in FIG. 7. Type field 1326-23 can indicate the type of IE (secure session identity). A Previous MAC field 1326-24 can be a MAC address from a last successful association. A secret code field 1326-25 can include a secret value established between and AP and STA in a previous session (e.g., association). In some embodiments, a secret code can be in a form protected by encryption, including but not limited to a cryptographic algorithm and/or cryptographic hash function. In some embodiments a secret code can be a PMK and/or PTK established in a most recent session, and thus known by both the AP and STA of the session, but not an imposter using a MAC address of the AP or STA.

In this way, a WLAN AP or STA can include a secure session identity IE in messages to enable a receiving device to confirm the presence of a shared secret for additional security, including prevention of attacks by imposters using the MAC address of a device associated with, or previously associated with, a wireless system.

After establishing secure session context values upon joining a network, embodiments can include update messages for updating such secure session context values.

FIG. 14 is a diagram of a secure session update data frame 1428 according to an embodiment. A body 1428-1 can include data indicating changes to secure session data 1428-10. In response to receiving such a data frame 1428, a device can update one or more parameters of the corresponding secure session.

In this way, secure session parameters can be updated in the event features of a connection change.

FIG. 15 is a diagram of a WLAN compatible secure session update data frame 1526 according to an embodiment. A MAC header 1528-0 can indicate a management frame, such as an action frame, and that the data frame is protected 1528-01 (e.g., a PMF).

A frame body 1528-1, which can be encrypted, can include data for updating features of a secure session. A field 1528-20 can indicate a type of data frame (i.e., secure session update). A Secure session ID field 1528-21 can include a secure session ID established in previous communications. A OP field 1528-22 can indicate a type of operation (e.g., add or delete data for the secure session). Action, Timeout, Session Type, and Secure Data Len fields 1528-23 to 1528-26, can take the form of those described in FIG. 9, or an equivalent. In the same way, optional Session data field 1528-3, and its Local IP, Local Port, Remote IP and Remote Port fields 1528-30 to-33 can take the form of those described in FIG. 9.

In this way, a WLAN STA can transmit updated values for a secure session to an AP in a data frame. In some embodiments, such a data frame can be transmitted by a STA prior to starting a session, to ensure such a session can be a secure session as described herein or an equivalent.

FIG. 16 is a diagram of a secure session update acknowledgement (ACK) data frame 1630 according to an embodiment. A data frame 1630 can be transmitted in response to a secure session update data frame like that of FIG. 14. A body 1630-1 can include data 1630-2 acknowledging a secure session update data frame. Such data 1630-2 can indicate whether or not an update operation was successful.

In this way, secure session update data frame can be answered with parameters can be updated in the event features of a connection change.

FIG. 17 is a diagram of a WLAN compatible secure session update ACK data frame 1730 according to an embodiment. A MAC header 1730-0 can indicate a management frame 1730-00, such as an action frame, and that the data frame is protected 1730-01 (e.g., a PMF).

A frame body 1730-1, which can be encrypted, can include a Secure session update ACK field 1730-20, which can indicate of an update operation was completed. A Secure session ID field 1730-21 can acknowledge the session corresponding to the received secure session update data frame.

In this way, a WLAN AP can return a secure session ACK in response to receiving a secure session update data frame.

As noted for embodiments herein, an access device controlling access to a network can establish secure session data with a device joining a network, and share such secure session data with other access devices. In some embodiments, an access device can request secure session data from other access devices.

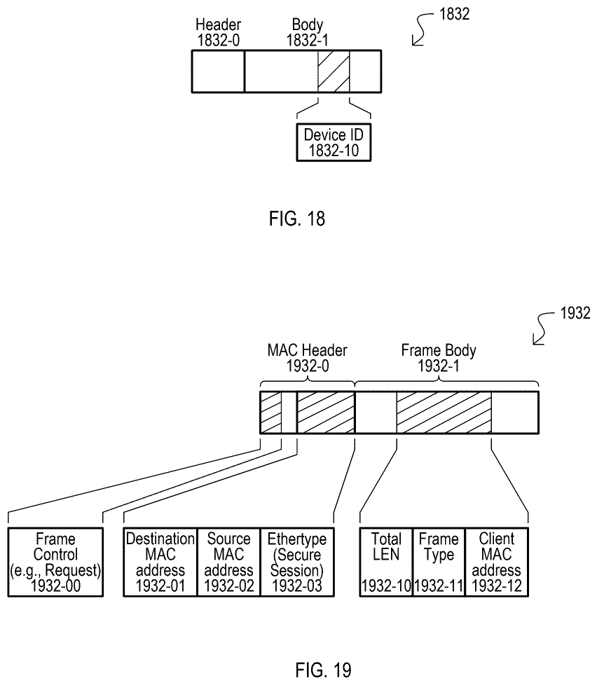

FIG. 18 is a diagram of a secure session data request frame 1832 according to an embodiment. A data frame 1832 can be compatible with one or more wireless standards, and can include a header 1832-0 and a body 1832-1. A body 1832-1 can include data indicating one or more device IDs 1832-10 for which secure session data are sought.

In this way, an access device can request secure session data from another access device to execute additional security operations.

FIG. 19 is a diagram of a WLAN compatible secure session context request frame 1932 according to an embodiment. In some embodiments, data frame 1932 can be a layer 2 (L2) data frame. A MAC header 1932-0 can indicate a control frame (e.g., request) 1932-00. A Destination MAC address field 1932-01 can be a broadcast address (for all other APs of a DS), or a unicast address (directed to a particular AP of a DS). A Source MAC address field 1932-02 can be an address of a requesting AP. An Ethertype field 1932-03 can indicate a secure session related request. A frame body 1528-1 can include an LEN field 1932-10, which can be indicate a length of a frame body. A Frame Type field 1932-11 can indicate a request. A Client MAC address field 1932-12 can indicate a MAC address for a STA of interest.

In this way, a WLAN AP can request secure session data for a STA of interest from one or more other APs of a same DS. Such a request can be issued in response to communications from a STA requesting reassociation or association.

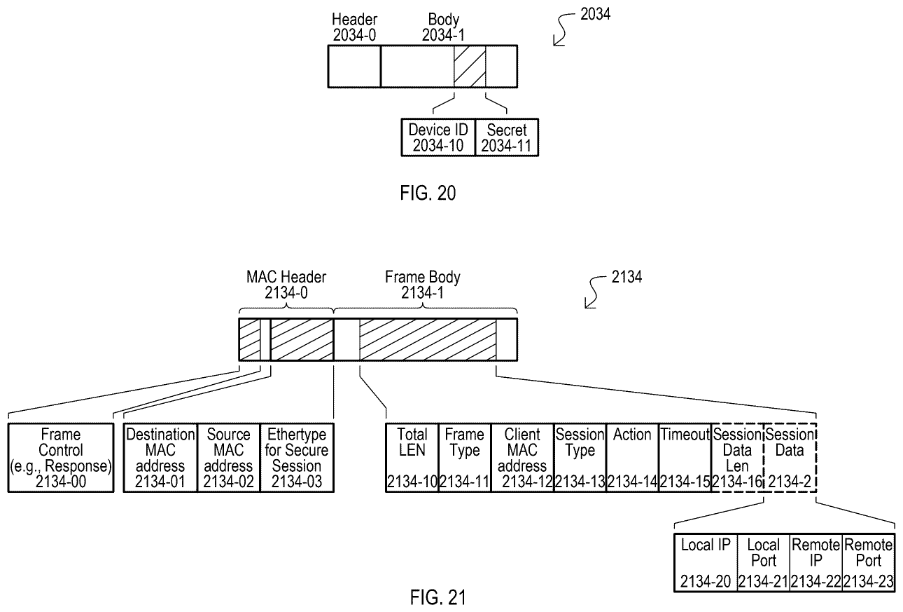

FIG. 20 is a diagram of a secure session data response frame 2034 according to an embodiment. A body 2034-1 can include data indicating one or more device IDs 2034-10 for which secure session data are sought, as well as secure session data corresponding to the device ID. In some embodiments, such data can include a shared secret 2034-11 corresponding to the device ID 2034-10.

In this way, an access device can transmit secure session data for a device ID indicated in a secure session data request.

FIG. 21 is a diagram of a WLAN compatible secure session context request frame 2134 according to an embodiment. A MAC header 2134-0 can indicate a control frame (e.g., request) 2134-00. A Destination MAC address field 2134-01 can be a unicast address (e.g., address of an AP of a same DS requesting secure session context data), or a multi-cast address (e.g., message for all APs of a DS). A Source MAC address field 2134-02 can correspond to the AP sending the data frame 2134. An Ethertype field 2134-03 can indicate a secure session related response. A frame body 2134-1 can include an LEN field 2134-10, which can indicate a length of a frame body. A Frame Type field 2134-11 can indicate a response. A Client MAC address field 2134-12 can indicate a MAC address for a STA corresponding to a request. A Session Type field 2134-13 can indicate a type of session (e.g., UDP or TCP). An Action field 2134-14 can indicate a type of action taken in response to a secure session verification failure (e.g., rejection connection, drop session packets for a timeout period). A timeout field 2134-15 can provide a timeout value for actions noted herein. A Session data length field 2137-17 and optional session data field 2134-2, 2134-20 to 2134-23 can correspond to those shown in FIG. 15 as 1528-26, 1528-3 and 1528-30 to 1528-33. In some embodiments, a frame body 2134-1 can include additional secure session data, including a shared secret.

In this way, a WLAN AP can provide secure session context data of an associated (or previously associated) STA to another AP of a same DS.

While the systems and devices described herein show various methods, additional methods will now be described with reference to flow diagrams. Such methods can be executed by circuits of devices and/or systems described herein.

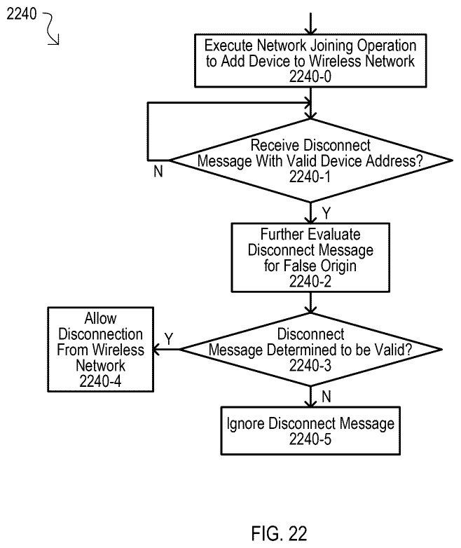

FIG. 22 is a flow diagram of a method 2240 according to an embodiment. A method 2240 can be executed by a wireless device that joins a network and/or controls access to a network. A method 2240 can include executing a network joining operation that adds a wireless device to a wireless network 2240-0. Such an action can include following steps suitable to an existing wireless standard. Once a device has joined a network, communications can occur over the wireless network according to the suitable standard(s).

Upon receiving a disconnect message, a method 2240 can determine if the message includes a valid device address 2240-1. Unlike some conventional operations, that may disconnect from a network in response to a such disconnect message, a method 2240 can further evaluate the message for false origin 2240-2. Such an action can include executing one or more additional security operations to ensure that the disconnection message has not originated from an impostor. Such additional security operations can include, but are not limited to, checking for shared secret value that was established when a device joined a network and transmitting a request to the apparent source of the disconnect message to elicit a response.

Based on further evaluations, a method 2240 can determine if a disconnect message is valid (e.g., not transmitted from an impostor) 2240-3. If the disconnect message is determined valid (Y from 2240-4) the message can be honored, and a device can be allowed to disconnect from the network 2240-4. However, if the message is determined to not be valid (N from 2240-4), a method 2240 can ignore the disconnect message 2240-5. In some embodiments, such an ignoring can be an action in addition to those included in the wireless standard under which the device is operating.

In this way, in response to a message to disconnect from a network, a device can execute security operations in addition to recognizing that the message indicates it originates from a valid device ID.

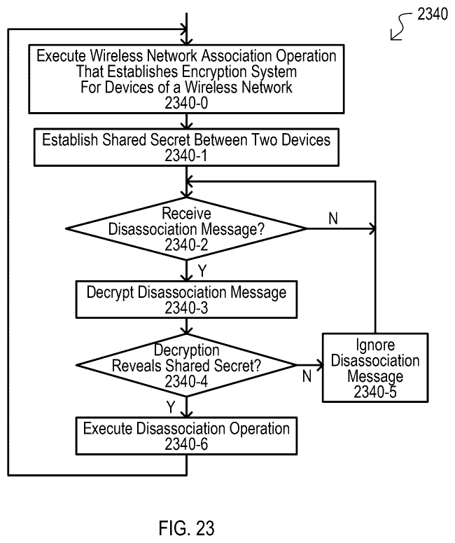

FIG. 23 is a flow diagram of a method 2340 according to another embodiment. A method 2340 can be executed by a device that associates with a wireless network and/or a device that controls access to a wireless network. A method 2340 can include executing a wireless network association operation that can establish an encryption system for the devices of the wireless network 2340-0. Such an action can include establishing one or more encryption keys according to an agreed upon standard.

A method 2340 can include establishing a shared secret between two devices. Such an action can include determining a secret value that can be unique to a connection. In some embodiments, a shared secret can be an encryption key, or a value derived from an encryption key. However, a secret value can be any other suitable value.

A method 2340 can determine if a disassociation message is received (2340-2). A disassociation message can be a message directing a device to cease communications with the network. If a disassociation message is received (Y from 2340-2), a message can be decrypted 2340-3. Such an action can include decrypting an entire payload, or portion thereof, using a decryption method established upon association. If decryption of a disassociation message does not reveal a shared secret (N from 2340-4), a received disassociation message can be ignored 2340-5. If decryption of a disassociation message reveals a shared secret, the disassociation operation indicated by the disassociation message can be executed 2340-6.

In this way, upon receiving a disassociation message, a wireless device can decrypt the message. If decryption does not reveal a shared secret, the disassociation message can be ignored.

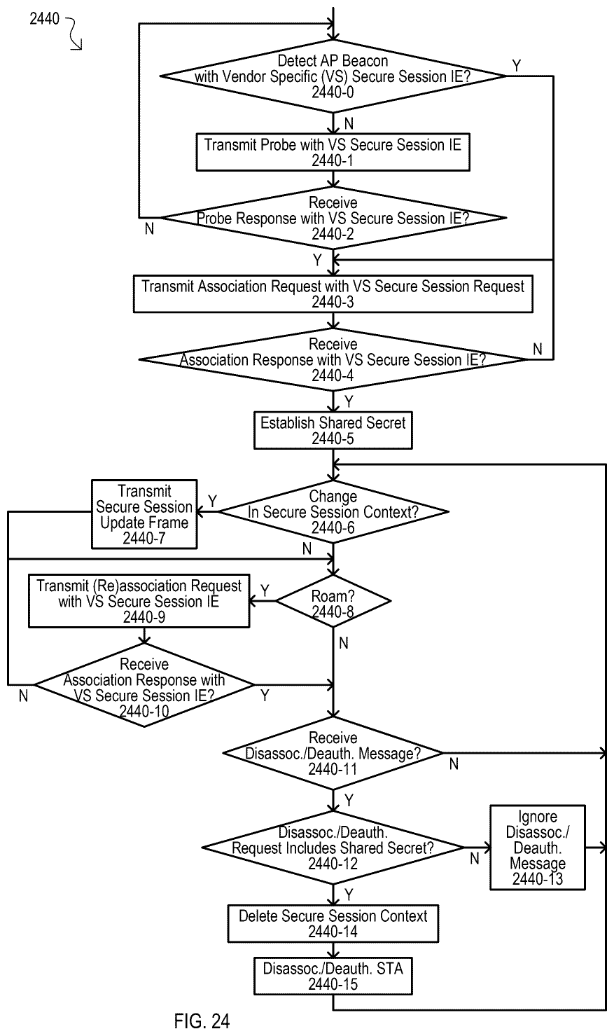

FIG. 24 is a flow diagram of a method 2440 for WLAN STA operations according to an embodiment. A method 2440 can include determining if an AP beacon with a VS secure session IE is detected 2440-0. Such an action can include detecting an AP beacon with a vendor specific field identifying secure session capabilities provided by an AP. In some embodiments, a VS secure session IE can take the form of that shown in FIG. 7, or an equivalent. In the embodiment shown, if an AP beacon with a VS secure session IE is not detected (N from 2440-0), a method 2440 can transmit a probe request with a VS secure session IE 2440-1. Such a VS secure session IE can take the form of that described for the beacon of 2440-0.

If a corresponding probe response is received (Y from 2440-2) or an AP beacon with VS a secure session IE was detected (Y from 2440-0), a method 2440 can transmit an association request that includes a request for secure session operations 2440-3. Such a response can include an indication of a type of action taken in response to secure session verification results (e.g., ignore, drop packets). If a corresponding secure session association response is received (Y from 2440-4), a secure session association operation can be complete. It is understood a secure session association operation can include establishing the encryption scheme for the corresponding system.

It is noted that while method 2440 shows a STA that can both look for secure session AP beacons and transmit secure session probe requests, alternate embodiments may only perform one such operation to detect a secure session capable AP. Further, such actions can depend on a mode of operation, or configuration of such a STA.

Once a secure session association is successful (Y from 2440-4), a method 2440 can establish a shared secret 2440-5. Such an action can include any of those described herein, or equivalents, including using a PMK and/or PTK generated during association.

In the embodiment shown, a method 2440 can include determining if there has been a change in secure session context 2440-6. In some embodiments, such an action can include monitoring data included in a VS secure session ID for changes. If there are changes in secure session data (Y from 2440-6), a method 2440 can transmit a secure session update frame 2440-7. Such a message can inform an AP of secure session changes. In some embodiments, such a message can take the form of that shown in FIG. 15. Although not shown in FIG. 24, a method 2440 can include continuing to transmit secure session update messages until an acknowledgement has been received from target AP(s).

In the embodiment shown, a method 2440 can also include determining when a roaming action has resulted in a STA choosing to connect with another AP 2440-8. Such an action can include roaming compatible with a WLAN standard. If a STA has roamed (Y from 2440-8), a (re)association request with a VS secure session IE can be transmitted to the target AP 2440-9. Such an action can follow those of 2440-3. If a corresponding association response is not received (N from 2440-10), a method 2440 can continue roaming operations (e.g., continue to seek reassociation).

In the embodiment shown, if a corresponding association response is received (Y from 2440-10), a method 2440 can determine if a disassociation or deauthentication (disassoc./deauth.) message is received 2440-11. In some embodiments, such an action can include determining of a such a message includes a valid source MAC address. If a disassoc./deauth. message is received (Y from 2440-11), a method 2440 can determine if such a message includes a shared secret 2440-12. In some embodiments, such an action can include decrypting the disassoc./deauth. message. In some embodiments, additional operations (e.g., decryption algorithm, cryptographic hash function) can be executed on a decrypted value. If a disassoc./deauth. message is determined not to include a shared secret (N from 2440-12), a method 2440 can ignore the message 2440-13. If a disassoc./deauth. message is determined to include a shared secret (Y from 2440-12), a method 2440 can delete secure session data for the connection 2440-14 (which can include any shared secret(s)), and the STA can perform the disassoc./deauth. operation indicated by the message 2440-15.

In this way, a WLAN STA can determine when an AP has secure session capabilities, and when associating with the AP, establish a shared secret. When the STA receives a disassociation or deauthentication message, if the message does not include the shared secret, the message can be ignored. A STA can update AP(s) in the event secure session data has changed.

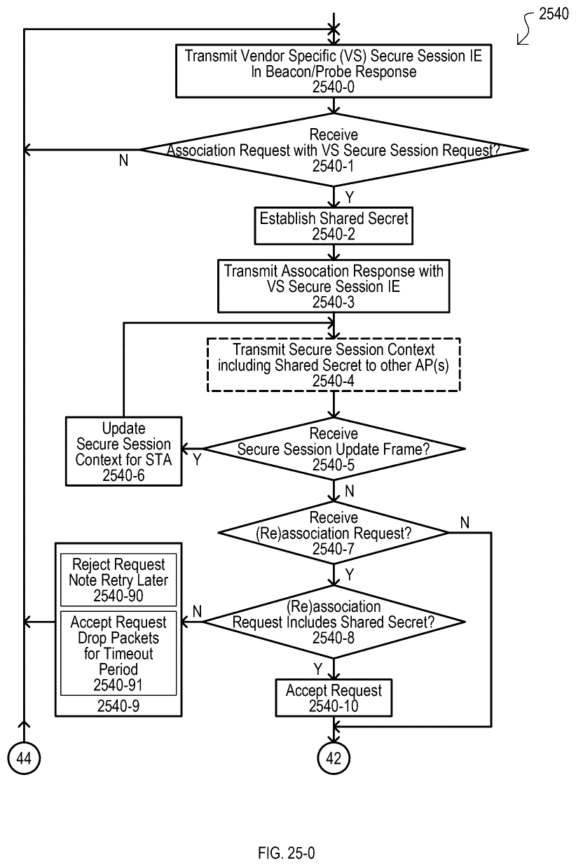

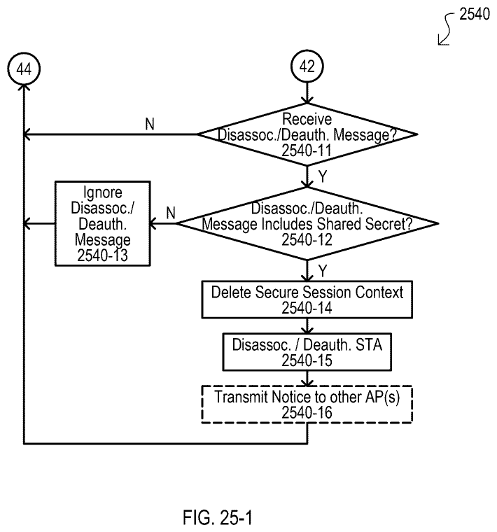

FIGS. 25-0 and 25-1 show a flow diagram of a method 2540 according to a further embodiment. The flow diagram shown in FIG. 25-0 can be connected to that of FIG. 25-1 at circles 42 and 44. A method 2540 can be executed by an AP to provide secure session security features to a corresponding BSS, including a BSS that is part of a DS.

Referring to FIG. 25-0, a method 2540 can include transmitting a VS secure session IE in a beacon or probe response 2540-0. Such an action can notify STAs of secure session capabilities provided by an AP. In some embodiments, such a transmitted message can take the form of that shown in FIG. 7 or an equivalent.

If an association request is received that also requests a secure session (Y from 2540-1), a method 2540 can establish a shared secret 2540-2 corresponding to a requesting STA, and return an association response 2540-3 indicating the secure session parameters 2540-3. In some embodiments, this can include a message with a VS secure session IE as described herein, or equivalents. Optionally, a method 2540 can include transmitting the secure session context data corresponding to the associating STA to other APs 2540-4. In some embodiments, this can include transmitting such information to other APs of a same DS. As understood from embodiments herein, such a transmission of secure session context data can be a gratuitous multicast and/or a unicast. Such a unicast transmission may be gratuitous or in response to a request from another AP.

A method 2540 can also include determining when secure session update frames are received 2540-5. In response to receiving such a data frame, a method 2540 can update secure session data for the corresponding STA 2540-6. A method 2540 can determine if a reassociation request or association request from a previously or currently associated device is received 2540-7. If such a (re)association request is received (Y from 2540-7), a method 2540 can determine if the message includes a shared secret corresponding to the requesting STA 2540-8. Such an action can include any of those described herein, or equivalents, including decrypting a portion of the message. If a shared secret is not included in the (re)association request (N from 2540-8), a method 2540 can take an action based on secure session data established in an initial association 2540-9. In the embodiment shown, such an action can include rejecting the request 2540-90 or accepting the request, but dropping packets corresponding to the session for a timeout period 2540-91. If a shared secret is included in the (re)association request (Y from 2540-8), a method 2540 can accept the request 2540-10.

Referring to FIG. 25-1, a method 2540 can include determining if a disassoc./deauth. message is received 2540-11. If such a message is received (Y from 2540-11), a method 2540 can determine if the message includes a shared secret 2540-12. Such an action can include any of those described herein or equivalents. If a shared secret is not included in the message (N from 1540-12), the message can be ignored 1540-13. If a shared secret is included in the message (Y from 1540-12), the secure session data corresponding to the disassoc./deauth. message can be deleted 1540-14, and the corresponding STA can be disassociated or deauthenticated 2540-15. Optionally, a method 2540 can include transmitting a notification to other APs regarding the disassoc./deauth. operation 2540-16.

In this way, an AP can inform potential associating STAs of its secure session capabilities with a broadcast or unicast message. Upon association with a STA, an AP can establish a shared secret with the STA. When a disassociation or deauthentication message for the STA is received, if such a message does not include the shared secret, the message can be ignored. When a reassociation request is received, if such a request does not include the corresponding shared secret, the request can be ignored, or alternatively honored, but with packets for the corresponding STA being dropped for a timeout period.

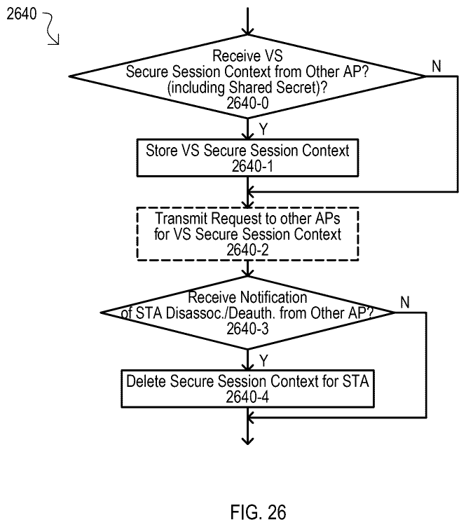

According to embodiments, APs can communicate secure session capabilities to other APs of a same system (e.g., DS). FIG. 26 is a flow diagram 2640 showing a method according to such an embodiment. It is understood the actions of FIG. 26 can be in addition to those shown in FIGS. 25-0 and 25-1. A method 2640 can include determining when VS secure session context data is received 2640-0. Such secure session context can include a shared secret. Such an action can include receiving a message from another AP. If such a message is received, the secure session context data can be stored 2640-1. It is understood such data can identify a STA (e.g., by a MAC address and/or other session data) and thus enable an AP to perform additional secure session actions in the event such a STA seeks reassociation. Optionally, or in alternative embodiments, a method 2640 can include transmitting a request to other APs for secure session context data 2640-2.

A method 2640 can include determining if a notification has been received regarding the disassoc./deauth. of a STA associated with another AP 2640-3. If such a notice is received (Y from 2640-3), a method 2640 can delete secure session data corresponding to the STA 2640-4.

In this way, an AP can receive and update secure session data from other APs.

While embodiments can include decryption of data frame fields to verify a shared secret, other embodiments can use transmitting messages to elicit a response for additional security.

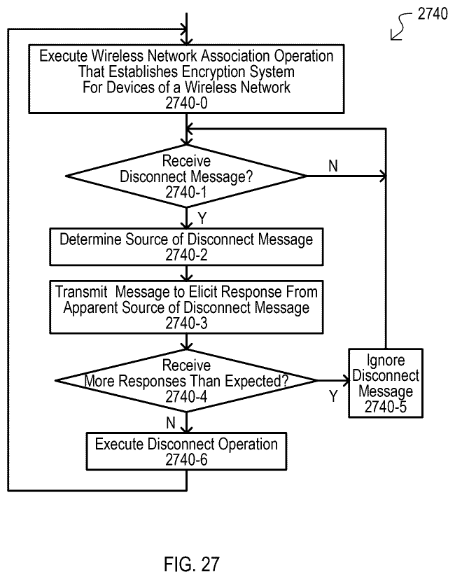

FIG. 27 is a flow diagram of a method 2740 according to another embodiment. A method 2740 can be executed a device that receives a message indicating it should disconnect from a network. A method 2740 can include executing a wireless association operation that establishes an encryption system for devices of a wireless network 2748-0. Such an action can include executing the steps according to a predetermined standard to join a network.

A method 2740 can determine if a disconnect message is received 2740-1. A disconnect message can take the form of any of those described herein or equivalents. If a disconnect message is received (Y from 2740-1), a method 2740 can determine an apparent source of the disconnect message 2640-2. Such an action can include examining data inherent in the received message (e.g., source address and/or other session data). A method 2740 can transmit a message to elicit a response from the apparent source of the disconnect message 2740-3. Such a message can take any suitable form, depending upon the standard under which a system is operating.

A method 2740 can determine if more response than expected are received 2740-4. If more response than expected are received (Y from 2740-5), the message to disconnect can be ignored 2740-5. Such a result can occur if an impostor issues a response(s) in addition to a valid device. If a number of responses received is as expected (N from 2740-5), a disconnect operation can be executed 2740-6.

It is noted that a method 2740 can determine a presence of an impostor without having to examine (e.g., decrypt) a body of a message. This can have lower computation needs than embodiments that check for a shared secret in a body of a data frame.

In this way, an impostor device sending a disconnect message, can be detected by sending a message to the apparent source of the message. If an impostor and valid device send responses, more responses than expected can be received, indicating the presence of an impostor, and the disconnect message can be ignored.

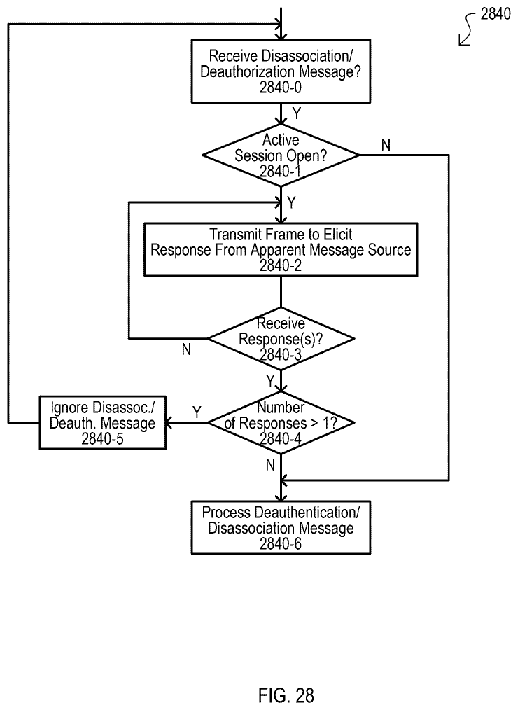

FIG. 28 shows a method 2840 for detecting an invalid disassoc./deauth. message according to an embodiment. A method 2840 can be executed by a WLAN compatible STA. A method 2840 can include receiving a disassoc./deauth. message 2840-0. A method 2840 can determine if a session corresponding to the message is still open 2840-1. Such an action can include any of those described herein, including but not limited to, checking for an open TCP/UDP port corresponding to the apparent source of the message, determining if any BA sessions corresponding to the apparent source are available and/or determining a AP has download data frames queued.

If a session is still open (Y from 2840-1), a method 2840 can transmit a frame to elicit a response from an apparent source of the disassoc./deauth. message 2840-2. Such an action can include any of those described herein, including but not limited to transmitting a BAR, PS-Poll or NDP. If response(s) are not received (N from 2840-3), a method 2840 can continue to attempt to elicit a response. If response(s) are received, a method 2840 can determine if a number of responses received exceeds a number expected 2840-4. In the embodiment shown, such an action can include determining if more than one response is received. The receipt of more than one response (Y from 2840-4) can indicate the presence of an imposter, such as a device using a MAC address of an AP, and the disassoc./deauth. message can be dropped 2840-5.

If a number of response is as expected (N from 2840-4) or there is no open session corresponding to the disassoc./deauth. message (N from 2840-1), a method 2840 can process the disassoc./deauth. message 2840-7.

In this way, when a STA receives a disassoc./deauth. message for an open session, the STA can send a message to the apparent source of the message to elicit a response. If more responses are received than are expected, the STA can drop (e.g., ignore) the disassoc./deauth. message.

While embodiments have described systems, methods, and corresponding devices, additional devices will now be described.

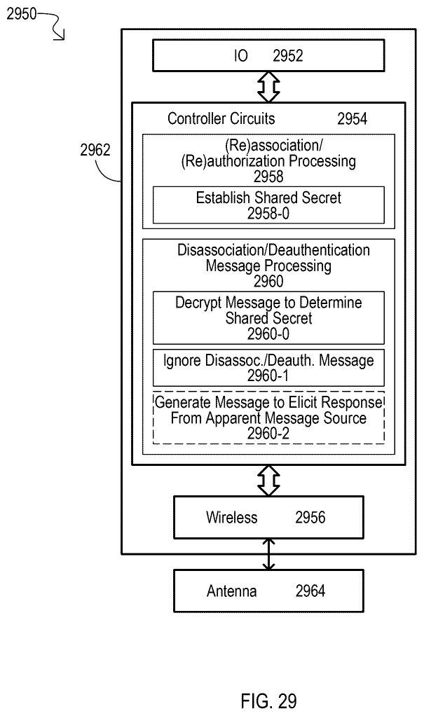

FIG. 29 is a block diagram of a wireless device 2950 according to an embodiment. A wireless device 2950 can control access to a network and/or be a device that joins a network. In some embodiments, a device 2950 can be an AP or STA of a network, including a WLAN compatible AP or STA in a BSS or DS. A device 2950 can include input/output (IO) circuits 2952, controller circuits 2954 and wireless circuits 2956. IO circuits 2952 can enable a device 2950 to communicate with other systems and/or a user, and can include any suitable communication circuits and/or interfaces, including wired and/or wireless circuits/interfaces.

Controller circuits 2954 can include any suitable circuits for executing wireless network access operations as described herein, and equivalents. Controller circuits 2954 can include, but are not limited to one or more processors, custom logic circuits, programmable logic circuits and/or machine learned/learning systems. Controller circuits 2954 can include circuits for processing association, reassociation and/or reauthentication ((re)assoc./(re)auth.) operations 2958 as well as disassociation and/or deauthentication (disassoc./deauth.) messages 2960. Processing (re)assoc./(re)auth.) operations 2958 can enable a device to join a network, including establishing an encryption scheme. In addition, a shared secret can be established 2958-0. Such an action can include any of those described herein and equivalents.

Processing disassoc./deauth. messages 2960 can include decrypting messages to determine a shared secret 2960-0. Such an action can include decrypting according to an established decryption scheme to determine a shared secret, or a value used to determine a shared secret. In some embodiments, determining a shared secret can be a security operation in addition to those provided by a standard under which a device is operating. Processing disassoc./deauth. messages 2960 can also include operations for ignoring a disassoc./deauth. message 2960-1. In some embodiments, such an operation can enable a device to ignore a disassoc./deauth. message that otherwise complies with a standard under which the device operates. In addition or alternatively, processing a disassoc./deauth. message 2960-0 can include generating a message to elicit a response from an apparent message source 2690-2. Such operations can follow those described herein and equivalents.

Wireless circuits 2956 can include circuits compatible with one or more standards, including public and/or private standards. In some embodiments, wireless circuits 2956 can be compatible with one or more IEEE 2902.11 or related standards. Wireless circuits 2956 can be connected to an antenna system 2964.

In some embodiments, IO circuits 2952, controller circuits 2954, and wireless circuits 2956 can be part of a same integrated circuit substrate 2962.

In this way, a wireless device can include controller circuits for establishing and storing a shared secret with another device in a network joining operation. Upon receiving a disassociation/deauthentication message, controller circuits can decrypt the message, and compare data in the decrypted data to the shared secret. In addition or alternatively, controller circuits can issue a message to elicit a response from an apparent source of the message.

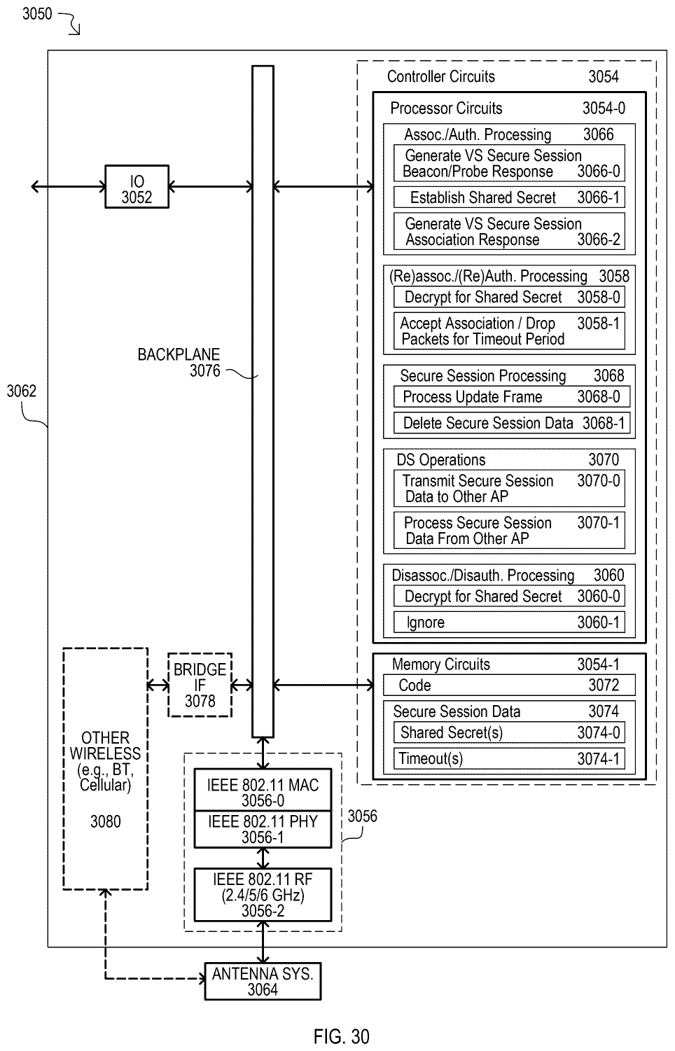

FIG. 30 is a block diagram of a device 3050 according to another embodiment. In some embodiments, a device 3050 can be one implementation of that shown in FIG. 29. In some embodiments, a device 3050 can be an WLAN compatible AP that can provide secure session capabilities to a BSS and/or DS. A device 3050 can include controller circuits 3054, WLAN circuits 3056, and optionally, other wireless circuits 3080 and bridge interface (I/F) circuits 3078 connected to one another over a backplane and/or bus 3076.

Controller circuits 3054 can include memory circuits 3054-1 and processor circuits 3054-0. Memory circuits 3054-1 can include any suitable memory circuits, including nonvolatile memory, volatile memory, and/or combinations thereof. According to embodiments, memory circuits 3054-1 can include circuits that are part of the device 3050 and/or memory circuits external to a device 3050 but accessible by processor circuits 3054-0 according to a wired or wireless protocol.

Memory circuits 3054-1 can store data for enabling the various operations of wireless device 3050, including enabling secure session operations that can address potential attacks using another device's MAC address. Memory circuits 3054-1 can be designed to store code (e.g., firmware) 3072 executable by processor circuits 3054-0 to provide the various processor circuits operations described herein. Memory circuits 3054-1 can also store secure session data 3074. Secure session data 3074 can include, but are not limited to, one or more shared secret(s) 3074-0 and/or timeout values 3074-1. Such values 3074-0/1 can take the form of any of those described herein or equivalents.

Processor circuits 3054-0 can execute code 3072 stored in memory circuits 3054-1 to provide various functions for the device 3050. Operations provided by processor circuits 3054 can include, but are not limited to, executing association/authentication (assoc./auth.) operations 3066, processing (re)assoc./(re)auth. requests 3058, executing secure sessions operations 3068, executing DS operations 3070, and processing disassoc./deauth. messages 3060. Executing assoc./auth. operations 3066 can include actions compatible with one or more IEEE 802.11 standards. However, unlike conventional AP operations, disassoc./deauth. processing 3066 can include generating VS secure session beacons and/or probe responses 3066-0, establishing a unique shared secret with each associating STA 3066-1, and generating secure session association responses 3066-2. Such actions can include any of those described herein or equivalents. In some embodiments, such operations can include generating data frames as shown in FIGS. 7 and 11.

Processing (re)assoc./(re)auth. requests 3058 can include decrypting such messages for a shared secret 3058-0. In some embodiments, such operations can include storing the received request data frame, determining a source of the request (e.g., source MAC address), decrypting a frame body of the request according to an encryption method established by a previous association operation. A decrypted field can then be compared to a stored shared secret corresponding to the source of the request to verify the request. Unlike conventional operations, if a secure session verification fails, processing a (re)assoc./(re)auth. requests 3058 can include accepting the request, but further dropping packets destined to the source of the request for a timeout period 3058-1.

Secure session processing 3068 can operate on secure session data established during an association operation. Such secure session data can include values in addition to those established by a selected IEEE 802.11 wireless standard. Secure session processing 3068 can include processing update frames 3068-0. In some embodiments, such operations can include receiving a data frame, determining from an IE which secure session data are to be updated (e.g., added, deleted, substituted). Secure session processing 3068 can also include deleting secure session data 3068-1. DS operations 3070 can include operations for sharing secure session data between APs of a DS. Such operations can include transmitting secure session data for other APs 3070-0, as well as processing secure session data received from other APs 3070-1.

Processing disassoc./deauth. messages 3060 can include decrypting such messages for a shared secret 3060-0, as described for embodiments herein. Unlike conventional operations, if a secure session verification fails, processing disassoc./deauth. messages 3060 can include ignoring such messages (as opposed to executing operations indicated by such messages).

Wireless circuits 3056 can provide wireless communications compatible with one or more wireless standards. Wireless circuits 3056 can include MAC layer circuits 3056-0, physical layer (PHY) circuits 3056-1, and RF circuits 3056-2. Such circuits (3056-0, -1, -2) can be compatible with one or more IEEE 802.11 wireless standards, on any suitable band, including but not limited to the 2.4 GHz, 5 GHz and/or 6 GHz bands.

IO circuits 3052 can input or output signals that can enable control of a device 3050 from sources external to the device according to any suitable fashion. In some embodiments, IO circuits 3052 can include serial communication circuits, including but not limited to interfaces compatible with a serial digital interface (SDI), universal serial bus (USB), universal asynchronous receiver transmitter (UART), I2C, or I2S.

Bridge interface circuits 3078 can enable communications between wireless circuits 3056 and other wireless circuits 3080. In some embodiments, such communications can control which wireless circuits (3056 or 3080) can operate on a shared medium (e.g., 2.4 GHz band). Other wireless circuits 3080 can be one or more wireless circuits compatible with standard other than WLAN, including but not limited to, one or more BT standards, one or more IEEE 802.15.4 or related standards and/or one or more cellular network standards.

A device 3050 can operate in conjunction with an antenna system 3064 having one or more antennas compatible with one or more wireless standards, including those of other wireless section 3080, if included.

In some embodiments, IO circuits 3052, controller section 3054, and wireless circuits 3056 can be formed with a same integrated circuit substrate 3062.

In this way, a WLAN compatible AP can provide additional security capabilities using secure session data established in an association operation which can include a shared secret. Received message can be verified by checking for shared secret data. If verification fails, a message can be ignored, or some other action can be taken that is in addition to the standard under which the AP is operating.

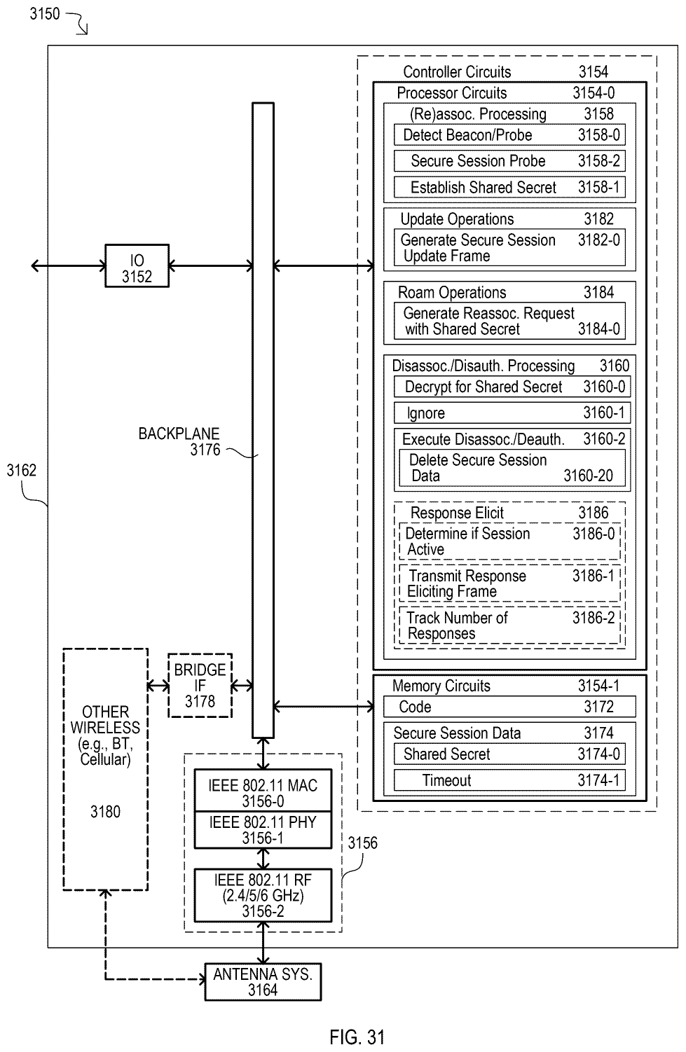

FIG. 31 is a block diagram of a device 3150 according to a further embodiment. In some embodiments, a device 3150 can one implementation of that shown in FIG. 29. In some embodiments, a device 3150 can be a WLAN compatible STA that can associate with, and then operate under, secure session capabilities. A device 3150 can include items like those of FIG. 30, and such like items are referred to with the same reference characters but with the leading digits being “31”instead of “30”.

Operations provided by processor circuits 3154 can include, but are not limited to, (re)association processing 3158, update operations 3182, roam operations 3184, and disassoc./deauth. processing 3160. In addition or alternatively, processor circuits 3154-0 can execute response eliciting operations 3186. (Re)association processing 3158 can include operations involved in associating with, or reassociating with a BSS. Such processing can include detecting an AP beacon or probe response indicating secure session capabilities 3158-0. Such actions can include detecting a secure session IE contained within a beacon. In addition or alternatively, a device 3050 can generate a secure session probe 3158-2 to elicit corresponding probe responses from APs with secure session capabilities. Update operations 3182 can include generating secure session update frames 3182-0. Such data frames can be transmitted, as described herein, in the event secure session data for a device 3150 has been changed. Such data frames can be multi-cast or unicast.

Roam operations 3184 can be executed by a device 3150 in response to signal conditions, to enable device 3150 to seek other APs to associate with in the event a connection with a current AP has become undesirable. Unlike conventional operations, roam operations 3184 can include generating reassociation requests with secure session data, including but not limited to a shared secret 3184-0.

Disassoc./deauth. processing 3160 can include decrypting received messages to check for a shared secret 3160-0. In contrast to conventional STA operations, disassoc./deauth. processing 3160 can include ignoring such messages 3160-1 in the event of a secure session verification failure. In addition, upon successful disassociation/deauthentication, secure session data can be deleted 3160-20.

In some embodiments, disassoc./deauth. processing 3160 can include response eliciting operations 3186. Such operations can include determining if a disassoc./deauth. message corresponds to an active session 3186-0, transmitting a response eliciting frame 3186-1 and tracking a number of responses received 3186-2 from a response eliciting frame.

In this way, a STA device can provide additional security capabilities using secure session data established in an association operation. A STA can update such data with transmissions to an AP and use such data in reassociation operation and to verify disassoc./deauth. messages. Alternatively, a STA device can elicit responses from an apparent source of disassoc./deauth. message to detect an impostor.

While embodiments can include systems and devices with various interconnected components, embodiments can also include unitary devices having the ability to protect wireless networks against attacks that utilize a device address of a device already associated with the network. FIG. 32 show one example of a packaged single chip wireless device 3250 according to an embodiment. Such a device 3250 can include circuits for executing secure session operations as described herein and equivalents. In some embodiments, a device 3250 can include circuits like those shown in any of those shown in FIGS. 29 to 31.

However, it is understood that a device according to embodiments can include any other suitable integrated circuit packaging type, as well as direct bonding of a device chip onto a circuit board or substrate.

In this way, a wireless device that can protect against insider attacks can be included in a single integrated circuit device.

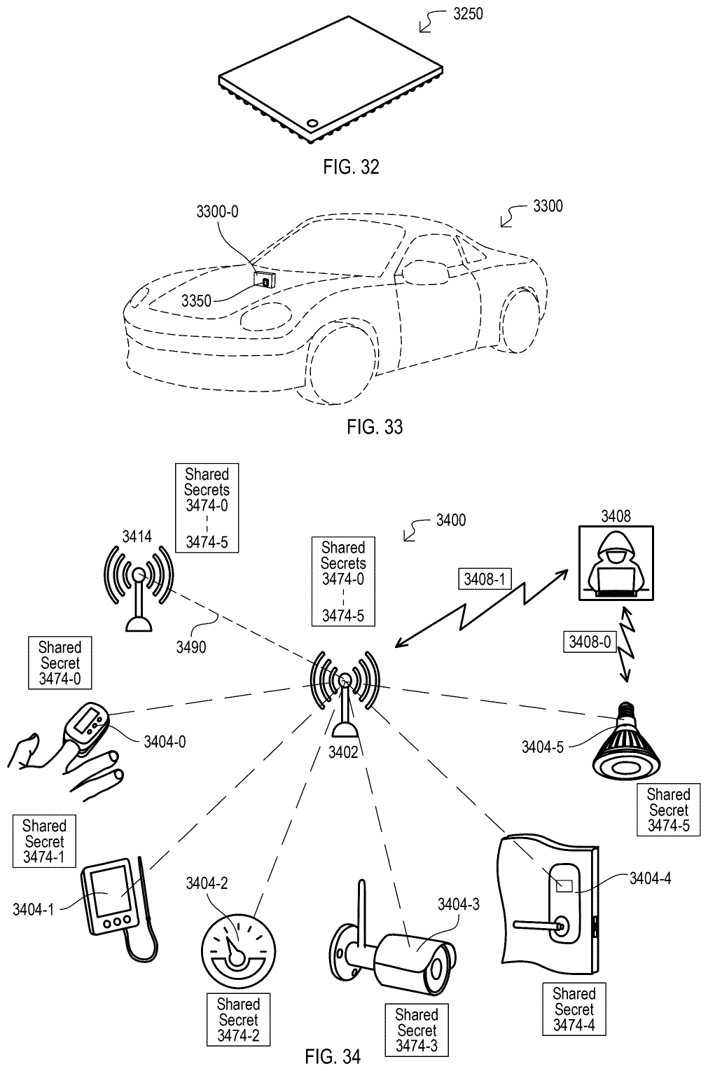

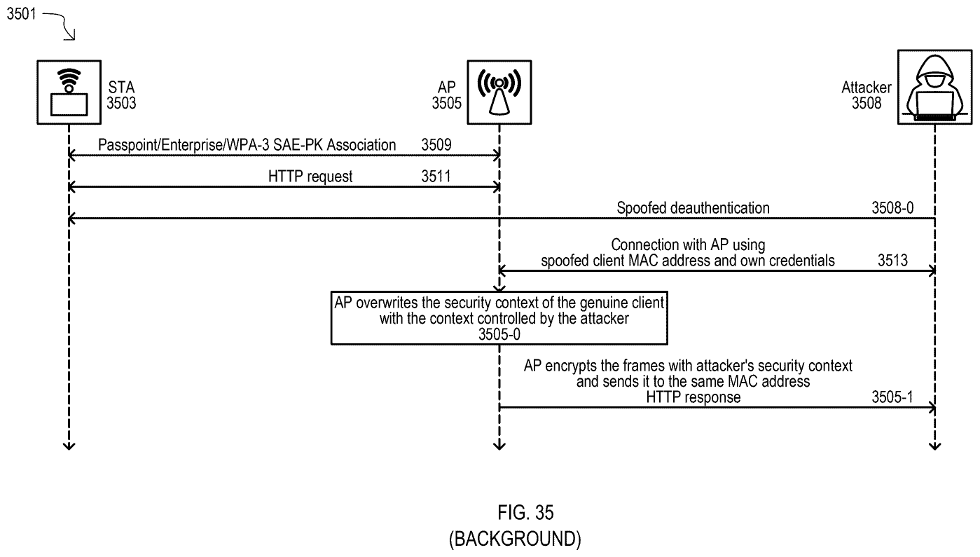

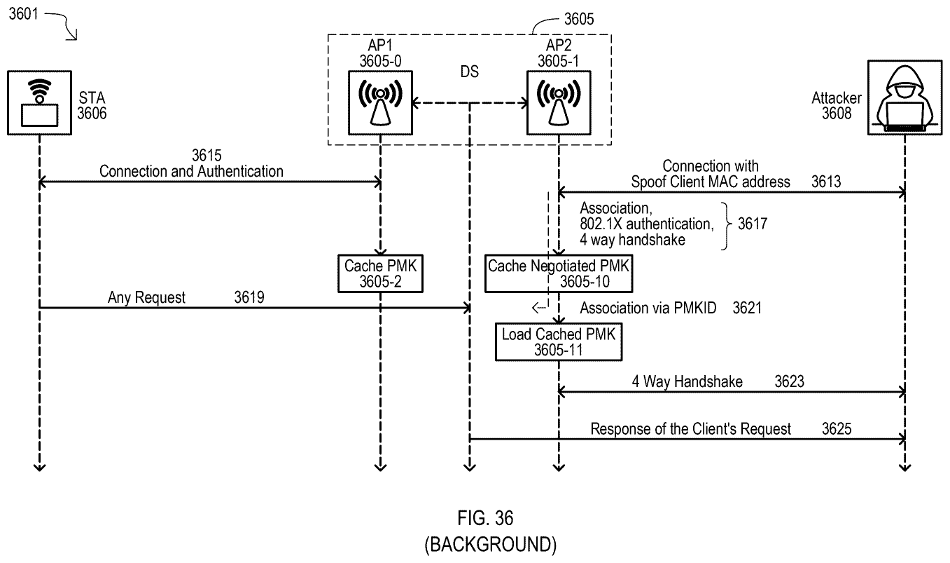

While embodiments can enjoy wide application in various wireless systems, vehicle systems can benefit from the resistance to insider information attacks as described herein. FIG. 33 shows a motor vehicle system 3300 according to an embodiment. A motor vehicle system 3300 can include one or more subsystems 3300-0 (e.g., in-vehicle infotainment system) that can include a wireless device 3350 in the form of any of those described herein, or equivalents. In some embodiments, such a wireless device 3350 can operate as a “soft-AP”and/or a STA.

In this way, vehicles can include a vehicle wireless system that can prevent insider information attacks that utilize addresses of devices already associated with the vehicle wireless system.

FIG. 34 shows a system 3400 according to another embodiment. A system 3400 can include two or more APs 3402, 3414 as well as a number of STAs 3404-0 to 3404-5. APs 3402/3414 and/or STAs (3404-0 to-5) can include devices as described herein and/or circuits for executing the various methods described herein.

APs 3402/3414 can establish secure session data upon association with a STA, as described herein or equivalents. Such secure session data can include shared secrets 3474-0 to 3474-5. APs 3402/3414 can be in communication with one another over a connection 3490, that may be wireless or wired. Over such a connection 3490, APs 3402/3414 can update secure session data that they establish when a STA associates with a DS. Thus, AP 3414 can be in possession of the same shared secrets as AP 3402.

In some embodiments, STAs (3404-0 to-5) can included in Internet-of-things (IoT) type devices, including but not limited to, medical devices 3404-0/1, instrumentation devices 3404-2, security devices 3404-3/4 or lighting devices 3404-5.

However, such wireless devices are provided by way of example, and any suitable wireless device can benefit from additional security operations as described herein or equivalents. STAs (3404-0 to-5) can associate with a network through AP 3402. Each STA (3404-0 to-5) an have a corresponding shared secret 3474-0 to 3474-5.

If an attacker 3408 attempts to force disassociation of a STA (3404-0 to -5) with a spoofed disassoc./deauth. frame 3408-0, a STA (3404-0 to-5) can detect the attacker by checking such a message for a shared secret and/or eliciting a response from the attacker 3408. If an attacker 3408 requests to join a system 3400 at AP 3402 or 3414, either AP (3402/3414) can check such a request for shared secret (3474-0 to -5). If such a shared secret is missing, the request can be ignored, or alternatively, honored, but corresponding download data can be dropped for a timeout period.

While a system 3400 can be a WLAN compatible network, alternate embodiments can include any other suitable standard/protocol.

Along these same lines, a system 3400 can include various interconnected networks, including piconets, PANs, LANs, WANs, both private and public, as well as the Internet.

Embodiments can include methods, devices and systems that include, by operation of a first wireless device, receiving wireless messages from a wireless network, and determining that a received wireless message is a disconnect message directing the first wireless device to end communications over the wireless network. A received disconnect message can be determined to be invalid in response to decrypting at least a portion of the received disconnect message and failing to find a shared secret value previously established during a network joining operation of the first wireless device. A received disconnect message can also be determined to be invalid in response transmitting a query message addressed to at least a source address of the received disconnect message and receiving more response messages than expected. An invalid message can be ignored.

Embodiments can include methods, devices and systems having wireless circuits configured to receive and transmit wireless messages according to at least one wireless standard and processor circuits. Processor circuits can be configured to determine that a received wireless message is a disconnect message directing the device to end communications over the wireless network. Processor circuits can determine that the received disconnect message is not valid in response to decrypting at least a portion of the received disconnect message and failing to find a shared secret value previously established during a network joining operation of the first wireless device. Processor circuits can also determine that the received disconnect message is not valid after transmitting a query message addressed to at least a source address of the received disconnect message and receiving more response messages than expected. An invalid disconnect message can be ignored.

Embodiments can include methods, devices and systems having a first wireless device configured to execute network joining operations to enable joining wireless devices to access a wireless network, the network joining operation establishing secure session data for the joining wireless devices. Secure session data can include at least device IDs of the joining wireless devices and shared secret values with the joining wireless devices. Identity check operations can be executed in response to receiving a network joining request having a device ID of the secure session data. Identity check operations can include decrypting the network joining request, and in response to the decrypted network joining message not including the shared secret value, ignoring the network joining message. Identity check operations can also include executing a network joining operation with a wireless device issuing the network joining message but dropping any wireless messages for transmission to the device ID for a predetermined timeout period.

Methods, devices and systems according to embodiments can include a disassociation or deauthentication frame compatible with at least one IEEE 802.11 wireless standard.

Methods, devices and systems according to embodiments can include a query message being selected from the group of: a block acknowledgement request, a power savings poll message, and a null data frame.

Methods, devices and systems according to embodiments can include, by operation of the first wireless device, executing a network joining operation, comprising exchanging messages with a second wireless device to establish encryption operations for wireless messages on the wireless network, and establish at least the shared secret.

Methods, devices and systems according to embodiments can a network joining operation comprising an association operation compatible with at least one IEEE 802.11 wireless standard.

Methods, devices and systems according to embodiments can include a first wireless device comprising a first AP compatible with at least one IEEE 802.11 wireless standard that is part of a distributed system. By operation of the first wireless device, at least the shared secret can be transmitted in an encrypted message to a second AP of the distributed system.

Methods, devices and systems according to embodiments can include a first wireless device comprising an AP compatible with at least one IEEE 802.11 wireless standard that is part of a distributed system (DS). By operation of the first wireless device, secure session data for a STA can be generated and stored during association with the STA. Secure session data can include at least a device address of the STA and a corresponding shared secret that is shared with the STA. Secure session data for at least one other STA associated with at last one other AP of the DS can be received and stored. In response to receiving a reassociation request having a device address of stored session data, the reassociation request can be decrypted, and executed if the decrypted reassociation request includes at least the corresponding shared secret. The reassociation request can be ignored if it does not include at least the corresponding shared secret.

Methods, devices and systems according to embodiments can include a first wireless device comprising an AP compatible with at least one IEEE 802.11 wireless standard that is part of a DS. By operation of a first wireless device, secure session data for a STA can be generated and stored during association with the STA. Secure session data can include at least a device address of the STA and a corresponding shared secret with the STA. Secure session data can be received and stored for at least one other STA associated with at least one other AP of the DS. In response to a receiving a reassociation request having a device address of stored session data, the reassociation request can be decrypted and a reassociation operation can be executed. Packets for transmission to the reassociated STA can be dropped for a predetermined timeout period if the decrypted reassociation request does not include at least the shared secret.

Methods, devices and systems according to embodiments can include wireless circuits that are compatible with at least one IEEE 802.11 wireless standard, and a received disconnect message can comprise a disassociation or deauthentication message.

Methods, devices and systems according to embodiments can include wireless circuits that are compatible with at least one IEEE 802.11 wireless standard, and a query message selected from the group of: a block acknowledgement request, a power savings poll message and a null data frame.

Methods, devices and systems according to embodiments can include processor circuits configured to execute the network joining operation. The network joining operation can include exchanging messages with another wireless device to establish encryption operations for wireless messages on the wireless network, and establishing at least a shared secret.

Methods, devices and systems according to embodiments can include processor circuits configured to transmit at least the shared secret in an encrypted message to another device of the wireless network, and receive shared secrets corresponding to other wireless devices of the wireless network.

Methods, devices and systems according to embodiments can include a wireless network that is compatible with at least one IEEE 802.11 wireless standard. Network joining operations can comprise association operations. A device ID can comprise a MAC address. A network joining message can comprise an association request or reassociation request.

Methods, devices and systems according to embodiments can include a second wireless device configured to transmit additional secure session data to a first wireless device. Additional secure session data can comprise device IDs and shared secret values of other joining wireless devices that have executed network joining operations with the second wireless device. A first wireless device can be configured to transmit its secure session data to the second wireless device, and execute the identity check operations in response to receiving a network joining request having a device ID of the secure session data or additional secure session data.

Methods, devices and systems according to embodiments can include a wireless network that is compatible with at least one IEEE 802.11 wireless standard. A first wireless device and second wireless devices can comprise access point devices of a same distributed system. Secure session data for the first wireless device can correspond to STAs associated with the first wireless device. Additional secure session data can correspond to STAs associated with the second wireless device.

Methods, devices and systems according to embodiments can include at least one joining wireless device configured to execute message check operations in response to receiving a disconnect message directing the joining wireless device to stop communications on the wireless network. Message check operations can comprise decrypting the received disconnect message, and in response to the decrypted disconnect message including a shared secret value of the joining device, executing actions directed by the disconnect message. In response to the decrypted disconnect message not including the shared secret value of the joining device, the disconnect message can be ignored.

Methods, devices and systems according to embodiments can include at least one joining wireless device configured to execute message check operations in response to receiving a disconnect message directing the joining wireless device to stop communications on the wireless network. Message check operations can comprise transmitting a query message to a device address corresponding to the disconnect message, and in response to receiving more responses than expected to the query message, ignoring the disconnect message.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of a first wireless device
receiving wireless messages from a wireless network,
determining that a received wireless message is a disconnect message directing the first wireless device to end communications over the wireless network,
determining that the received disconnect message is not valid in response to
decrypting at least a portion of the received disconnect message, and failing to find a shared secret value previously established during a network joining operation of the first wireless device, or
after transmitting a query message addressed to at least a source address of the received disconnect message, receiving more response messages than expected, and
ignoring the received disconnect message if it is determined to be not valid.

2. The method of claim 1, wherein the received disconnect message comprises a disassociation or deauthentication frame compatible with at least one IEEE 802.11 wireless standard.

3. The method of claim 2, wherein the query message is selected from the group of:
a block acknowledgement request, a power savings poll message, and a null data frame.

4. The method of claim 1, further including:
by operation of the first wireless device, executing the network joining operation, comprising exchanging messages with a second wireless device to
establish encryption operations for wireless messages on the wireless network, and
establish at least the shared secret.

5. The method of claim 4, wherein the network joining operation comprises an association operation compatible with at least one IEEE 802.11 wireless standard.

6. The method of claim 4, further including:
the first wireless device comprises a first access point device (AP) compatible with at least one IEEE 802.11 wireless standard that is part of a distributed system; and
by operation of the first wireless device, transmitting at least the shared secret in an encrypted message to a second AP of the distributed system.

7. The method of claim 1, further including:
the first wireless device comprises an access point device (AP) compatible with at least one IEEE 802.11 wireless standard that is part of a distributed system (DS);
by operation of the first wireless device,
generating and storing secure session data for a station device (STA) during association with the STA, secure session data including at least a device address of the STA and a corresponding shared secret that is shared with the STA,
receiving and storing secure session data for at least one other STA associated with at last one other AP of the DS,
in response to receiving a reassociation request having a device address of stored session data, decrypting the reassociation request, and
executing a reassociation operation request if the decrypted reassociation request includes at least the corresponding shared secret, and
ignoring the reassociation request if the decrypted reassociation request does not include at least the corresponding shared secret.

8. The method of claim 1, further including:
the first wireless device comprises an access point device (AP) compatible with at least one IEEE 802.11 wireless standard that is part of a distributed system (DS);
by operation of the first wireless device,
generating and storing secure session data for a station device (STA) during association with the STA, secure session data including at least a device address of the STA and a corresponding shared secret with the STA,
receiving and storing secure session data for at least one other STA associated with at least one other AP of the DS,
in response to receiving a reassociation request having a device address of stored session data,
decrypting the reassociation request and executing a reassociation operation, and
dropping packets for transmission to the reassociated STA for a predetermined timeout period if the decrypted reassociation request does not include at least the shared secret.

9. A device, comprising:
wireless circuits configured to receive and transmit wireless messages according to at least one wireless standard; and
processor circuits configured to
determine that a received wireless message is a disconnect message directing the device to end communications over the wireless network,
determine that the received disconnect message is not valid in response to
decrypting at least a portion of the received disconnect message, and failing to find a shared secret value previously established during a network joining operation of the first wireless device, or
after transmitting a query message addressed to at least a source address of the received disconnect message, receiving more response messages than expected, and
ignoring the received disconnect message if it is determined to be not valid.

10. The device of claim 9, wherein:
the wireless circuits are compatible with at least one IEEE 802.11 wireless standard; and
the received disconnect message comprises a disassociation or deauthentication message.

11. The device of claim 9, wherein:
the wireless circuits are compatible with at least one IEEE 802.11 wireless standard; and
the query message is selected from the group of: a block acknowledgement request, a power savings poll message and a null data frame.

12. The device of claim 9, wherein:
the processor circuits are further configured to execute the network joining operation comprising
exchanging messages with another wireless device to establish encryption operations for wireless messages on the wireless network, and
establishing at least the shared secret.

13. The device of claim 12, wherein:
the wireless circuits are compatible with at least one IEEE 802.11 wireless standard; and
the network joining operation comprises an association operation.

14. The device of claim 9, wherein:
the processor circuits are further configured to
transmit at least the shared secret in an encrypted message to another device of the wireless network; and
receive shared secrets corresponding to other wireless devices of the wireless network.

15. A system, comprising:
a first wireless device configured to
execute network joining operations to enable joining wireless devices to access a wireless network, the network joining operation establishing secure session data for the joining wireless devices that includes at least
device identification values (IDs) of the joining wireless devices, and
shared secret values with the joining wireless devices,
execute identity check operations in response to receiving a network joining request having a device ID of the secure session data, the identity check operations comprising
decrypting the network joining request,
in response to the decrypted network joining message not including the shared secret value,
ignoring the network joining message, or
executing a network joining operation with a wireless device issuing the network joining message but dropping any wireless messages for transmission to the device ID for a predetermined timeout period.

16. The system of claim 15, wherein:
the wireless network is compatible with at least one IEEE 802.11 wireless standard;
the network joining operations comprise association operations;
the device ID comprises a media access control (MAC) address; and
the network joining message comprises an association request or reassociation request.

17. The system of claim 15, further including:
a second wireless device configured to transmit additional secure session data to the first wireless device, the additional secure session data comprising device IDs and shared secret values of other joining wireless devices that have executed network joining operations with the second wireless device; and
the first wireless device is further configured to
transmit its secure session data to the second wireless device, and
execute the identity check operations in response to receiving a network joining request having a device ID of the secure session data or additional secure session data.

18. The system of claim 17, wherein:
the wireless network is compatible with at least one IEEE 802.11 wireless standard;
the first wireless device and second wireless devices comprise access point devices of a same distributed system;
the secure session data for the first wireless device corresponds to station devices (STAs) associated with the first wireless device; and
the additional secure session data corresponds to STAs associated with the second wireless device.

19. The system of claim 15, further including:
at least one joining wireless device configured to execute message check operations in response to receiving a disconnect message directing the joining wireless device to stop communications on the wireless network, the message check operations comprising
decrypting the received disconnect message,
in response to the decrypted disconnect message including a shared secret value of the joining device, executing actions directed by the disconnect message, and
in response to the decrypted disconnect message not including the shared secret value of the joining device, ignoring the disconnect message.

20. The system of claim 17, further including:
at least one joining wireless device configured to execute message check operations in response to receiving a disconnect message directing the joining wireless device to stop communications on the wireless network, the message check operations comprising
transmitting a query message to a device address corresponding to the disconnect message,
in response to receiving more responses than expected to the query message, ignoring the disconnect message.
